(19) United States
(12) Patent Application Publication
(10) Pub. No.: US 2002/0128894 A1
(43) Pub. Date: Sep. 12, 2002

(54) System for recruiting candidates for employment

(76) Inventor: Rose Mary Farenden, W. Bloomfield, MI (US)

Correspondence Address: BROOKS & KUSHMAN P.C./FGTI, 1000 TOWN CENTER, 22ND FLOOR, SOUTHFIELD, MI, 48098, US

(21) Appl. No.: 09/800,986

(22) Filed: Mar. 7, 2001

Related U.S. Application Data
(60) Provisional application No. 60/240,810, filed on Oct. 16, 2000.

(51) Int. Cl. G06F 17/60

(52) U.S. Cl. 705/8

(57) ABSTRACT

An internet-based system for recruiting candidates for employment is provided. A server is configured to receive employment requisitions having candidate matching criteria, host an interactive interface for presenting a candidates for employment with an employment skills questionnaire, assess each candidate based on a comparison between each candidate's employment skills and the candidate matching criteria and host an interactive interface for allocating invitations to an employer-hosted recruiting event to candidates based on the assessment. The server may also be configured to host an interface for defining, scheduling and receiving candidate assessments in real time during the employer-hosted recruiting events. Candidates are selected for hire in real time during the recruiting events and receive an offer/no offer letter electronically prior to the conclusion of their respective event.

### CROSS-REFERENCE TO RELATED APPLICATIONS

This application claims the benefit of U.S. provisional application Serial No. 60/240,810, filed Oct. 16, 2000. This application is related to the following commonly owned and copending applications: WEB SITE FOR RECRUITING CANDIDATES FOR EMPLOYMENT, filed ______ (Attorney Docket No. FMC 1335 PUS, 200-1707); and METHOD FOR RECRUITING CANDIDATES FOR EMPLOYMENT, filed ______ (Attorney Docket No. FMC 1303 PUSP, 200-1417).

### BACKGROUND OF THE INVENTION

1. Field of the Invention

This invention relates generally to recruiting candidates for employment and, more specifically, to a system for recruiting candidates for employment.

2. Background Art

Recruiting candidates for professional employment is a burdensome and multi-faceted task. Conventional professional recruiting comprises defining overall hiring objectives (i.e., target number of hires, diversity targets, etc.), training recruiters, defining and advertising employment opportunities, managing candidate resumes and background information, scheduling candidate interviews, visits and career fairs, traveling to and staffing candidate interviews, visits and career fairs, evaluating and comparing candidates, making offers to qualified candidates, negotiating offers, confirming acceptance or rejection of the offers and managing the various tasks associated with bringing a new employee on-board (i.e., scheduling medical examinations, background checks, drug tests and relocating the candidate).

Often, several tiers of employer personnel participate in the recruiting process. For example, corporate executives may define overall hiring objectives. The personnel department may manage the candidate resumes. Other departments or committees may manage recruiter training, employment requisitions, advertising and the various recruiter-candidate activities (interviews, career fairs, campus visits, etc.). As a result of the volume, distribution and nature of the various recruiting tasks, communication and cooperation among the participants is often redundant, decentralized and ineffective.

In addition, scheduling and rescheduling the various tasks among recruiting staff and candidates is often very tedious and cumbersome. The personal schedule of every manager, recruiter and candidate participating in the recruiting process must be taken into account and coordinated among one another.

Another problem with conventional recruiting is the candidate experience. Often, the candidate-recruiter or candidate-employer relationship is impersonal and unreasonably brief. Candidates are often forced to make substantial professional employment decisions based on one or two formal, brief and uncomfortable encounters with a recruiter. Moreover, candidates often wait weeks or months after an interview to receive an employment offer or rejection. Considering that most professional employment offers include a deadline for response, candidates are often forced to decide on an offer from one employer before they know whether they will receive an offer from another employer that they have just interviewed with. In addition, candidates who receive rejections are seldom provided feedback explaining why they have been rejected and how they might improve their chances of employment in the future.

What is needed is a solution for efficiently streamlining the recruiting process from initially defining hiring objectives to finally getting the most qualified candidates on-board with the employer. The solution should comprise a method and system through which each of the various tasks associated with the recruiting process are defined, coordinated and managed. In addition, the solution should provide candidates with a more personal experience that allows the candidates to comfortably and efficiently participate in the recruiting process. Candidates should have a greater level of interactivity with the recruiter during the recruiting process. Preferably, the solution provides the candidates with an offer or rejection soon after they are evaluated so that the candidates are not forced into making premature employment decisions. Candidates receiving a rejection should be provided with feedback explaining why they have been rejected and how they might improve their chances of employment in the future.

### SUMMARY OF THE INVENTION

An internet-based system for recruiting candidates for employment is provided. The system comprises at least one server computer operably connected to at least one database and serving a plurality of client computers. The at least one server computer is configured to host and perform several tasks associated with recruiting candidates for employment in accord with the present invention. The server is configured to receive input defining a plurality of employment requisitions wherein each employment requisition has associated candidate matching criteria. The server is additionally configured to host an interactive interface for presenting a plurality of candidates for employment with an employment skills questionnaire. The server is further configured to assess each candidate based on a comparison between each candidate's employment skills and the candidate matching criteria. The server is also configured to host an interactive interface for allocating the employer-hosted recruiting event invitations to candidates based on the assessment.

The server may additionally be configured to host an interface for presenting a profile of each candidate wherein each profile comprises an assessment of how well a candidate's employment skills match the candidate matching criteria.

The server may also be configured to host an interface for defining and scheduling the employer-hosted recruiting events. During the recruiting events, the server is configured to host an interface for receiving an assessment of each candidate attending an employer-hosted recruiting event. Candidate assessments during the employer-hosted recruiting event are received and reported by the system in real time and comprise an assessment of a candidate's interview performance, an assessment of a candidate's performance during a group observation exercise and a placement recommendation for the candidate wherein the recommendation is based on the candidate's discussions with a mentor. Candidates for hire are selected from the real time presentation of candidate assessments.

The server may be configured to present candidates selected for hire with an offer letter in an electronic format prior to the conclusion of the employer-hosted recruiting event.

### BRIEF DESCRIPTION OF THE DRAWINGS

FIG. 1 is a block flow diagram illustrating an overview of a hiring process in accord with the preferred embodiment of the present invention;

FIG. 2 is a system diagram illustrating the environment in which the present invention operates;

FIG. 3 is a block flow diagram illustrating an overview of the planning and preparation element of the hiring process;

FIG. 4 illustrates a system interface defining a target number of hires by function and monitoring the recruiting status in real time during the hiring process;

FIG. 5 illustrates a system interface for adding certified recruiters and event staff members to a database of certified recruiters and event staff;

FIG. 6 illustrates a system interface for searching the database of certified recruiters and event staff;

FIG. 7 illustrates a system interface for defining recruiter and event staff personal biographies;

FIG. 8 illustrates a system interface for defining recruiting teams;

FIG. 9 illustrates a system interface for defining invitations to an employer-hosted recruiting event, and distributing those invitations to recruiters;

FIG. 10 illustrates a system interface for adding university information to a database of recruiting venues;

FIG. 11 illustrates a system interface for adding university contact information to the database of recruiting venues;

FIG. 12 illustrates a system interface for adding professional organization information to the database of recruiting venues;

FIG. 13 illustrates a system interface for path B recruiter to schedule on-campus interviews, professional organization activities and career fairs;

FIG. 14 illustrates a system interface for defining employer-hosted recruiting event profiles;

FIG. 15 illustrates a system interface for defining general attributes of an employment requisition;

FIG. 16 illustrates a system interface for defining an abstract and detailed description of the employment requisition;

FIG. 17 illustrates a system interface for selecting default candidate matching components for the employment requisition;

FIG. 18 illustrates a system interface for defining basic candidate matching information for the employment requisition;

FIG. 19 illustrates a system interface for defining a candidate's education required for the employment requisition;

FIG. 20 illustrates a system interface for defining certifications and concentrations required for the employment requisition;

FIG. 21 illustrates a system interface for defining a candidate's grade point average required for the employment requisition;

FIG. 22 illustrates a system interface for defining candidate background information and candidate relocation preference information;

FIG. 23 illustrates a system interface for defining the technical skills and knowledge at a moderate proficiency level required for the employment requisition;

FIG. 24 illustrates a system interface for defining the technical skills and knowledge at a high proficiency level required for the employment requisition;

FIG. 25 illustrates a system interface for defining candidate experiences required for the employment requisition;

FIG. 26 illustrates a system interface for defining any additional unique qualifications required for the employment requisition;

FIG. 27 is a block flow diagram illustrating an overview of the candidate identification process;

FIG. 28 illustrates an introductory page at the candidate web site;

FIG. 29 illustrates an introductory page at the candidate web site having a multimedia recruiter profile presentation;

FIG. 30 illustrates an introductory page at the candidate web site having a text-based recruiter profile presentation;

FIG. 31 illustrates an introductory page at the candidate web site for creating a candidate's personal profile;

FIG. 32 illustrates a candidate web site page for inputting a candidate's contact information;

FIG. 33 illustrates the beginning web page for an on-line skills questionnaire at the candidate web site;

FIG. 34 illustrates the educational background portion of this on-line skills questionnaire at the candidate web site;

FIG. 35 illustrates a leadership behavior assessment portion of the on-line skills questionnaire at the candidate's web site;

FIG. 36 illustrates a personal experiences assessment portion of the on-line skills questionnaire at the candidate's web site;

FIG. 37 illustrates a job search page at the candidate web site;

FIG. 38 illustrates a search results web page at the candidate web site;

FIG. 39 illustrates a web page at the candidate web site containing a detailed job description;

FIG. 40 illustrates a page at the candidate web site containing a job pod;

FIG. 41 illustrates various elements of functionality associated with the job pod at the candidate web site;

FIG. 42 illustrates a candidate's interactive messaging center at the candidate web site;

FIG. 43 illustrates a page at the candidate web site for searching campus visits and career fairs;

FIG. 44 is a block flow diagram illustrating a detailed recruiting process for referred candidates;

FIG. 45 illustrates a system interface through which a path B recruiter defines a candidate profile and interview assessment;

FIG. 46 illustrates a system interface for managing a recruiter's candidate invitation account;

FIG. 47 illustrates an example candidate profile listing;

FIG. 48 illustrates an example candidate profile report;

FIG. 49 illustrates a system interface for searching candidate profiles;

FIG. 50 is a block flow diagram illustrating a recruiter's evaluation-invitation process for web recruited candidates;

FIG. 51 is a block flow diagram illustrating the search team evaluation-invitation process for job pool candidates that have requested consideration for current job opportunity;

FIG. 52 is a block flow diagram illustrating a recruiter's evaluation-invitation process for job pool candidates that have requested consideration for current job opportunities;

FIG. 53 is a block flow diagram illustrating an evaluation process for current interns;

FIG. 54 is a block flow diagram illustrating the recruiting process for preselected or agency conversion candidates;

FIG. 55 is a block diagram illustrating an overview of an employer-hosted recruiting event;

FIG. 56 is a block flow diagram illustrating the process by which invited candidates accept an invitation to an employer-hosted recruiting event;

FIG. 57 is a block flow diagram illustrating the preliminary event staff registration process;

FIG. 58 is a block flow diagram illustrating the final event staffing process;

FIG. 59 is a block flow diagram illustrating the employer-hosted recruiting event check in process;

FIG. 60 is a block flow diagram illustrating the candidate evaluation process that takes place during the employer-hosted recruiting event;

FIG. 61 illustrates a system interface through which a group assessor inputs the results of a candidate's group assessment during an employer-hosted recruiting event;

FIG. 62 illustrates a system interface through which a mentor inputs an assessment of each candidate mentored at the employer-hosted recruiting event;

FIG. 63 is a block flow diagram illustrating the process for making a hiring decision during the employer-hosted recruiting event;

FIG. 64 illustrates the process for extending offer/no offer letters to candidates attending the employer-hosted recruiting events;

FIG. 65 illustrates the process for extending the offer/no offer letters to current interns;

FIG. 66 illustrates the follow-up process for candidates who receive an offer letter at an employer-hosted recruiting event; and

FIG. 67 is a block flow diagram illustrating the medical examination process for new hires.

### DETAILED DESCRIPTION OF THE PREFERRED EMBODIMENT(S)

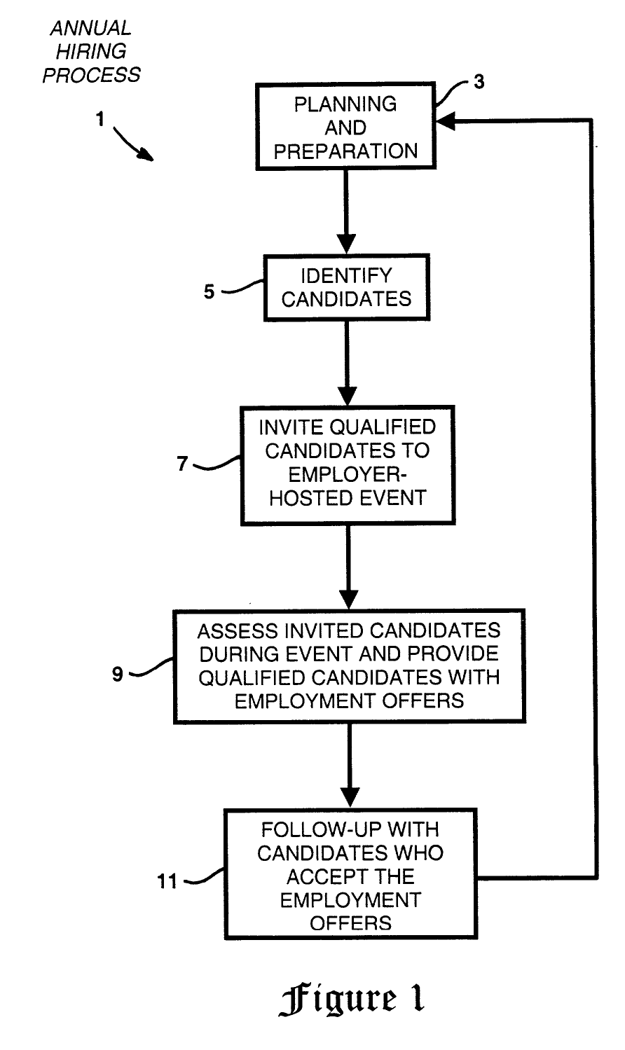

FIG. 1 is a block flow diagram illustrating a preferred embodiment of the present invention. Generally, the hiring process 1 comprises planning and preparation as described in block 3, identifying potential candidates for employment as described in block 5, inviting qualified candidates to employer-hosted events as described in block 7, assessing the invited candidates in real-time during the events and providing employment offers to candidates during an event as described in block 9. An additional aspect of the hiring process comprises candidate follow-up and finalizing the candidates' accession to their new employment as described in block 13 (e.g., validating educational credentials, conducting medical and drug screening, conducting background checks, relocating candidate, etc.).

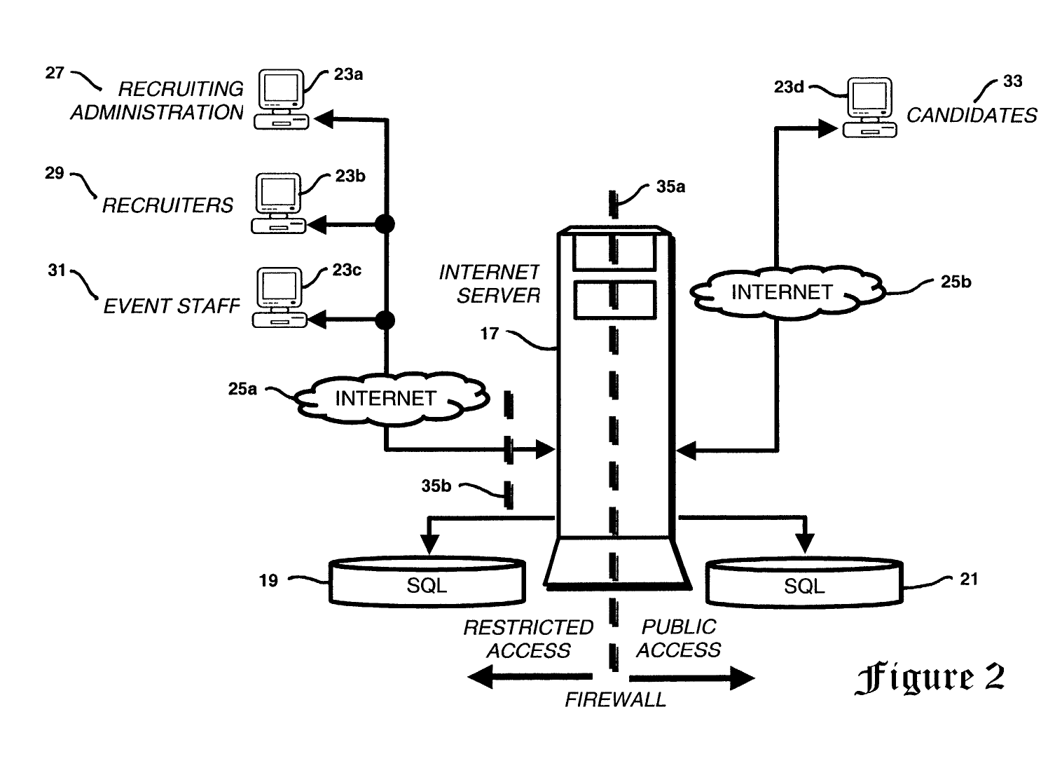

FIG. 2 illustrates a system (the “System”) for implementing the hiring process illustrated in FIG. 1. Notably, implementation of the hiring process illustrated in FIG. 1 is not limited to the System illustrated in FIG. 2.

Generally, the System comprises at least one server computer 17 operably connected to at least one secured sequential database 19 and 21 and serving a plurality of client computers 23a-23d. In accord with a preferred embodiment, the server computer serves the client computers via the Internet 25a and 25b including the World Wide Web.

In accord with the present invention, System users operating client computers 23a-23d include but are not limited to recruiting administrators 27, recruiters 29, recruiting event staff 31, and candidates 33.

At least one firewall 35a and 35b restricts access to the System according to predefined user privileges and restrictions. Recruiting administrators 27 assign all non-candidate System users (i.e., recruiters 29 and event staff 31) permissions which are enforced via login code and password. As discussed in detail infra, public access by candidates 33 is limited to a System-hosted candidate web site (not shown).

The System may be implemented utilizing programming languages and utilities including but not limited to hypertext mark-up language (HTML), dynamic hypertext mark-up language (DHTML),vector-based animation (e.g., Flash™) extensible mark-up language (XML), active server pages (ASP), virtual reality mark-up language (VRML), cascading style sheets (CSS), layering, server side includes (SSI), common gateway interfacing (CGI), C++ and Java. Data is stored in a secure sequel server database.

For purposes of clarity and organization, the remainder of the Detailed Description of the Preferred Embodiments is divided into five principal sections, each section corresponding to a separate element of the hiring process, illustrated in FIG. 1.

### Planning and Preparation

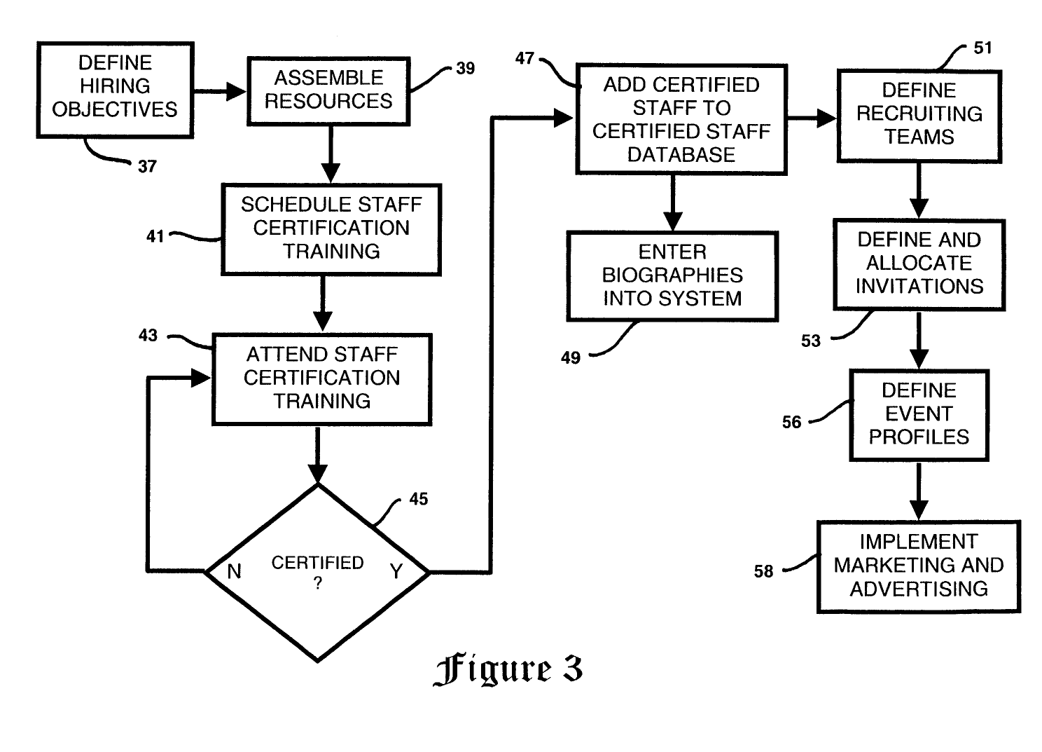

FIG. 3 is a block flow diagram illustrating an overview of the planning and preparation element of the hiring process. Generally, planning comprises defining the hiring objectives for the upcoming year as described in block 37. Preparation comprises assembling the resources necessary to meet those objectives. Hiring objectives for an upcoming year include but are not limited to a target number of hires, diversity targets, timing-of-hiring criteria and employment requisitions. To define the target number of hires, recruiting administration accesses the System and inputs the desired data.

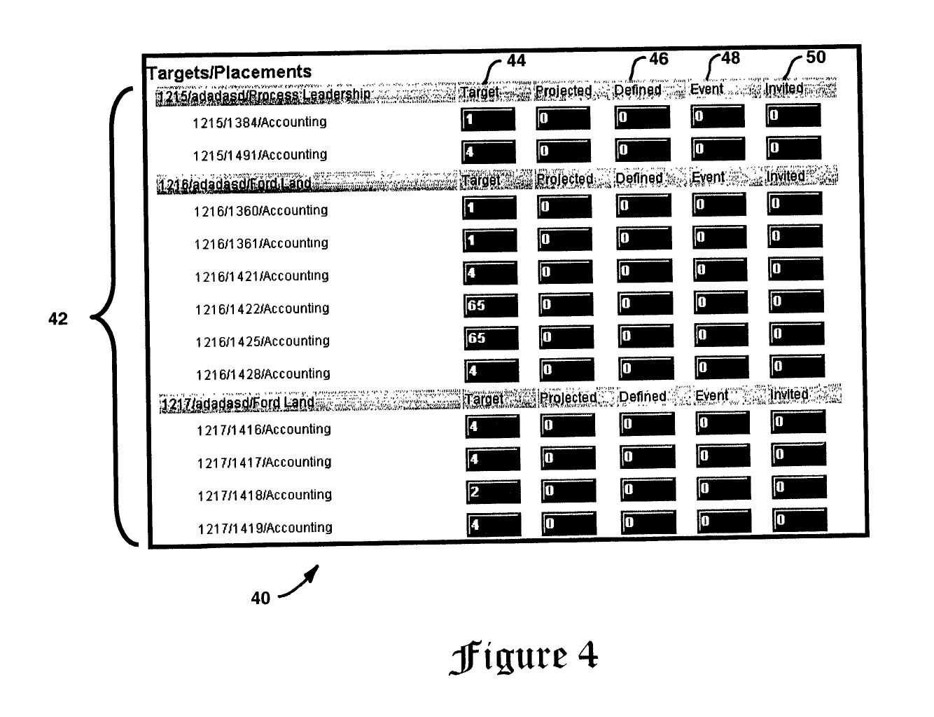

FIG. 4 illustrates a System interface 40 for defining a target number of hires 44 by function 42 and monitoring the recruiting status in real time during the hiring process. For each function 42, the number of corresponding defined placements 46, events 48 and invitations 50 is reported.

After the hiring objectives have been established, the resources or staffing necessary to meet those objectives are assembled as described in block 39. In accord with the present invention, staffing includes but is not limited to recruiters, event owners and event staff (e.g., candidate interviewers, candidate mentors, group observers and candidate buddies, discussed infra).

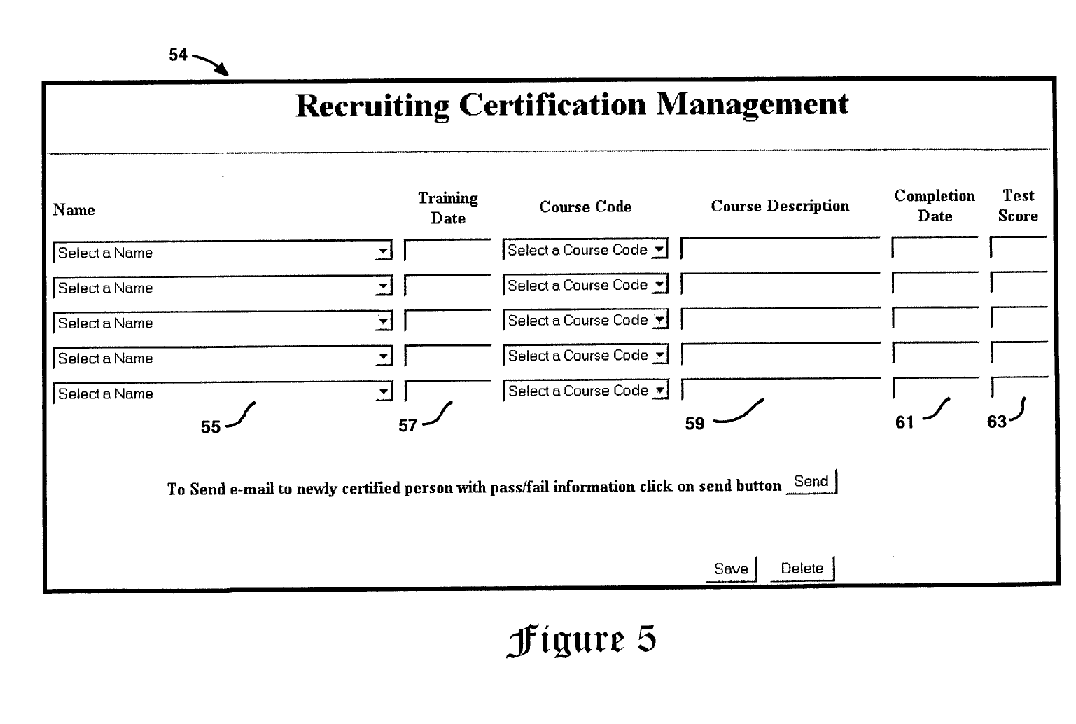

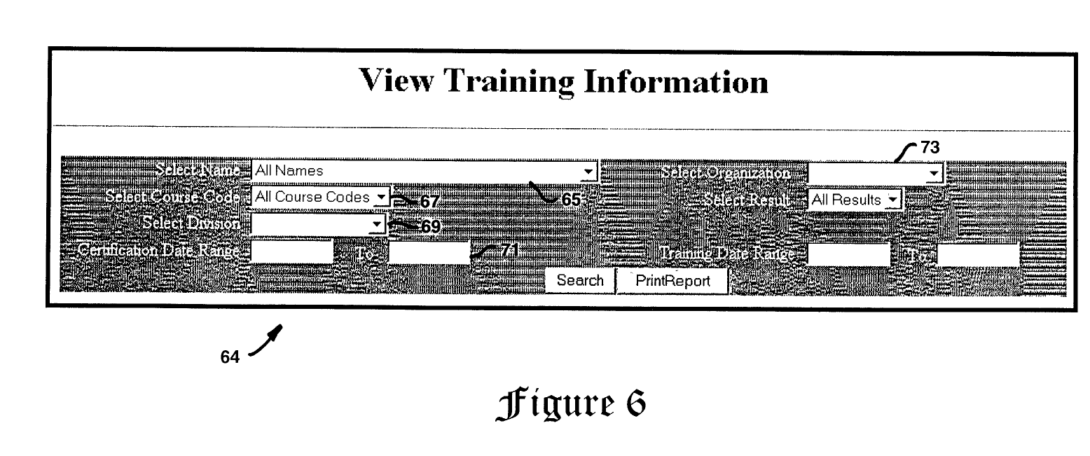

In accord with a preferred embodiment of the present invention, recruiters and event staff are trained and certified in their respective roles prior to their participation in the hiring process as described in blocks 41, 43, 45 and 47. A database of certified recruiters is maintained within the System. FIG. 5 illustrates a System interface 54 through which certified recruiters and event staff members (i.e., interviewers, mentors and assessors) are added to the database of certified recruiters and event staff. Each certification listing comprises the name of the person certified 55, the training date 57, the course description 59, the completion date 61 and the test score 63. FIG. 6 illustrates a System interface 64 through which recruiting staff can search the database of certified recruiters and event staff according to name 65, course code 67, division 69, date range 71 and organization 73.

Referring again to FIG. 3, each certified recruiter and event staff member accesses the System and defines a personal biography as described in block 49. Biographies are used during the candidate identification step of the hiring process to match recruiters and event staff members with candidates. As discussed in more detail infra, recruiter and event staff profiles may be posted on the candidate web site for viewing by potential candidates.

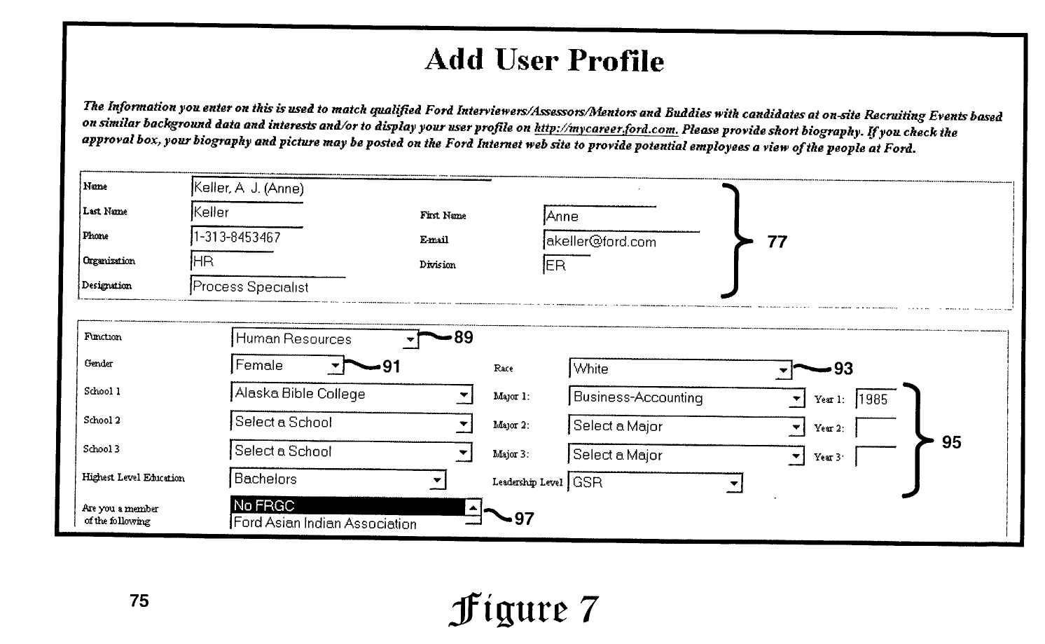

FIG. 7 illustrates a System interface 75 through which recruiters and event staff define their personal biographies or profiles. Biographies comprise the person's contact information 77, function 89, gender 91, race 93, education 95, professional association 97, and a mentor-candidate matching questionnaire (not shown).

Referring again to FIG. 3, recruiting teams are defined after the certified recruiter and event staff database has been assembled as described in block 51. Preferably, a recruiting team is defined for each university or professional organization at which the employer recruits employees.

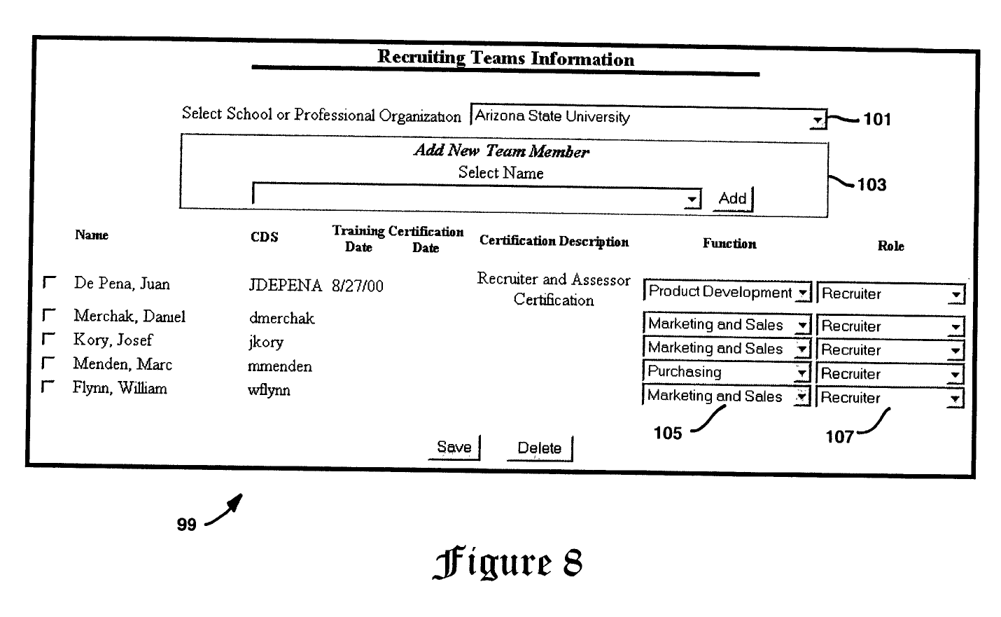

FIG. 8 illustrates a System interface 99 through which the recruiting teams are defined. Recruiting team definition comprises specifying the school or professional organization to which the team is assigned 101, team members 103, a function 105 and a recruiting role 107 for each team member.

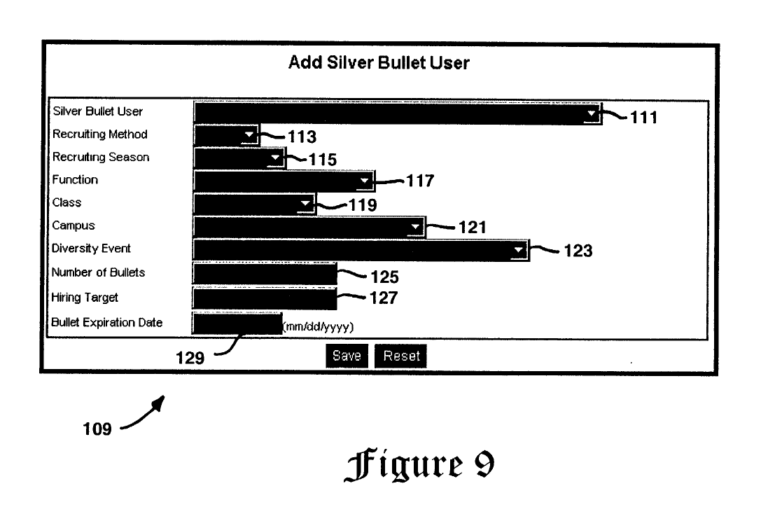

Referring again to FIG. 3, candidate invitations to employer-hosted recruiting events are next defined and distributed to recruiters as described in block 53. FIG. 9 illustrates a System interface 109 through which invitations are defined and distributed to recruiters. Each invitation definition comprises allocation criteria including but not limited to the name of the recruiter (i.e., the silver bullet user 111), the recruiting method (e.g., Path A or Path B, as discussed infra) 113, the recruiting season 115, the function for which the recruiter is recruiting 117, the class for which the recruiter is recruiting 119, the campus or professional organization assigned to the recruiter 121, any pre-scheduled events for that campus 123, the number of invitations (i.e., “Bullets”) given to each recruiter for inviting qualified candidates to employer-hosted recruiting events 125, the target number of hires for the recruiter 127 and the expiration date of the recruiter's invitations 129. As discussed infra, the System hosts a recruiting account for each recruiter to manage the candidate invitations he or she has been assigned.

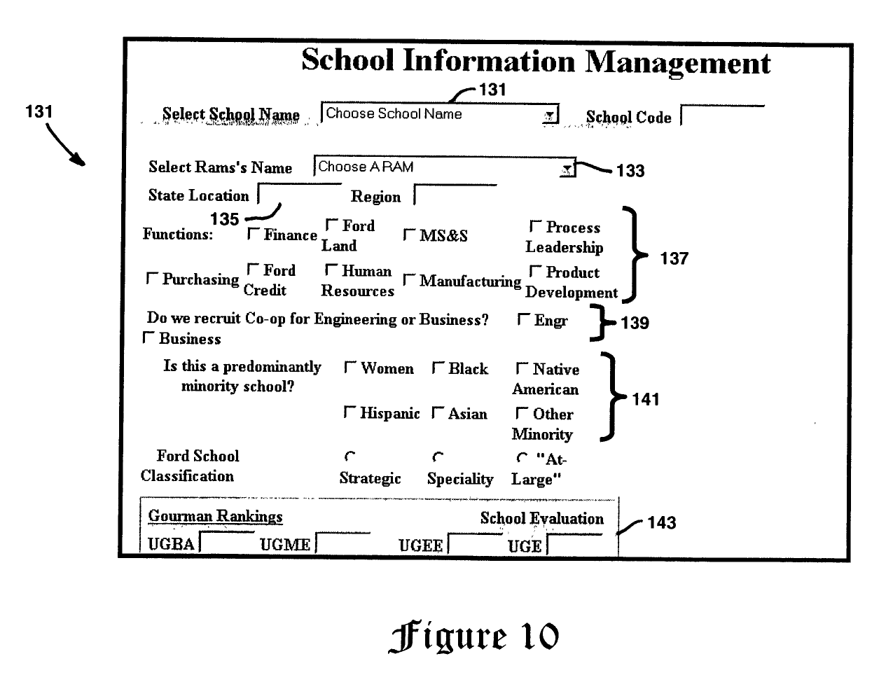

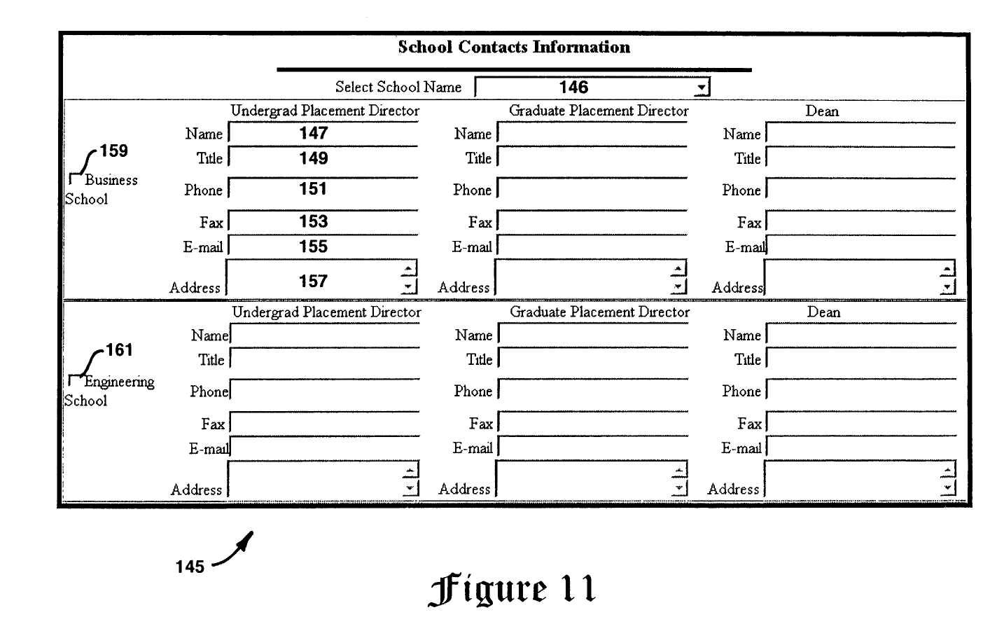

Referring again to FIG. 3, event profiles are next defined as described in block 56. A recruiting venue database is maintained within the System. Recruiting venues include but are not limited to universities and professional associations. FIG. 10 illustrates a System interface 131 through which university information is added to the database of recruiting venues. University information comprises the name of the university 131, a recruiting administrator assigned to the university 133, the location of the university 135, the employer departments (e.g., “functions”) for which the employer recruits at the university 137, co-op information 139, ethnicity information 141 and Gourman rankings 143. FIG. 11 illustrates a System interface 145 through which contact information for each university is input into the database of recruiting venues. Contact information for an input school 146 comprises the name 147, title 149, phone number 151, fax number 153, e-mail address 155 and mailing address 157 of each recruiting contact within the university (e.g., Undergraduate Placement Director, Graduate Placement Director, Dean, etc.). Preferably, contacts are input according to school department (i.e., business school 159, engineering 161, etc.).

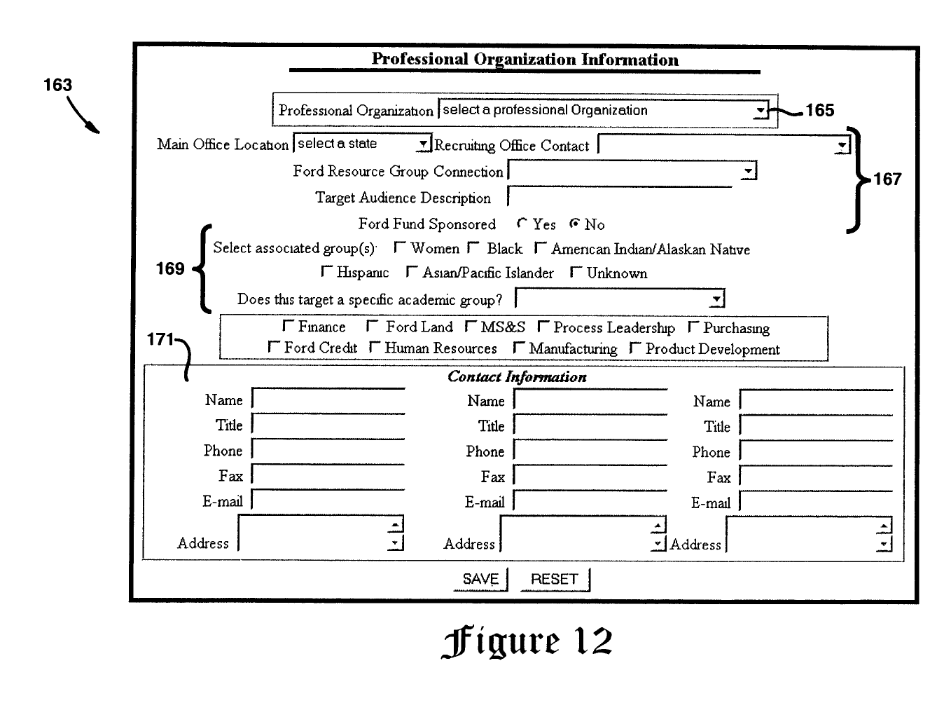

FIG. 12 illustrates a System interface 163 through which professional organization information is added to the database of recruiting venues. Professional organization information comprises the name of the organization 165, the location 167, ethnicity information 169 and contact information 171.

In accord with a preferred embodiment of the present invention, there are two recruiting methods for recruiters to choose from: “Path A” and “Path B”. Path A recruiters identify candidates to recruit based on candidate profile information compiled via the candidate web site, as discussed infra. Path B recruiters identify candidates to recruit through campus activities such as campus interviews, professional organization activities and career fairs.

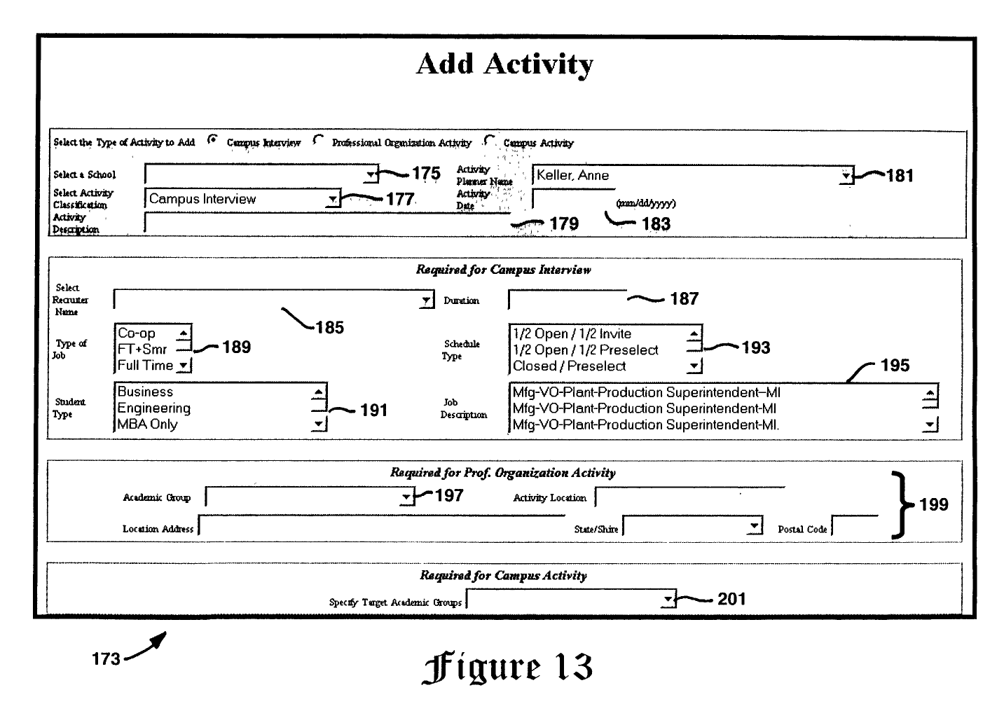

FIG. 13 illustrates a System interface 173 through which Path B recruiters schedule on-campus interviews, professional organization activities and career fairs. Each activity added comprises a school 175, an activity classification 177, an activity description 179, the name of the activity planner 181 and an activity date 183. To schedule a campus interview, the recruiter additionally enters the interviewer name 185, the length of the interview 187, the type of employment opportunity 189, the type of student 191, the schedule type 193, and a description of the employment opportunity 195. To schedule a professional organization activity, the recruiter additionally enters the academic group 197 and the activity location 199. To schedule a campus activity, the recruiter additionally enters the target academic group 201. As discussed infra, Path B recruiter activities are posted on the candidate web site.

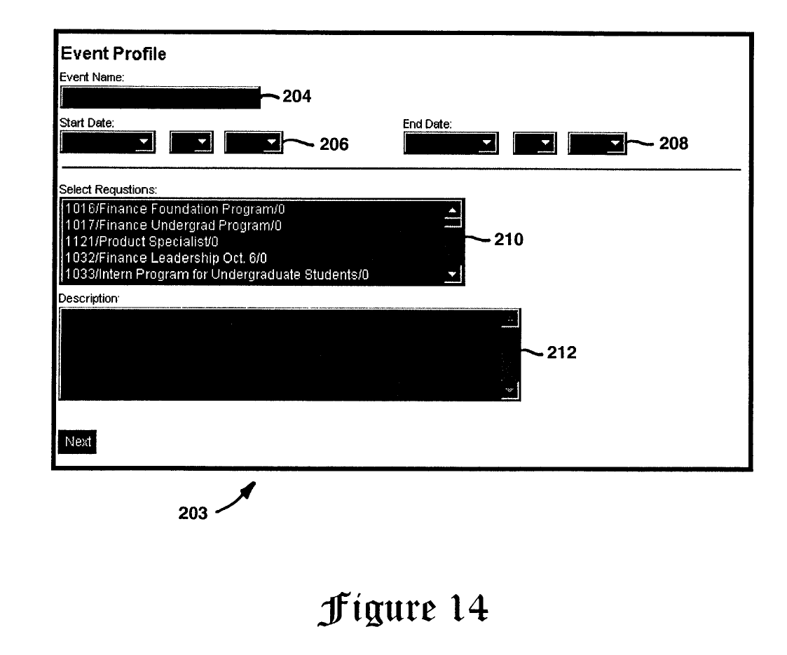

Referring again to FIG. 3, employer-hosted recruiting event profiles are defined as described in block 56. FIG. 14 illustrates a System interface 203 through which profiles for the employer-hosted events are defined. Employer-hosted events are discussed in more detail infra. Event profiles 203 comprise an event name 204, a start date 206 for the event, an end date 208 for the event, employment requisitions to be filled via the event 210 and a description of the event 212. Additional event definitions (not shown) comprise the event owner, the event type (e.g., business, technical, etc.), the target attendance ratio (e.g., staff member to candidate), the venue, the staffing and the keynote speaker (e.g., executive).

Referring again to FIG. 3, a brand team implements marketing and advertising plans based on the event profiles as described in block 58. In addition, the brand team notifies each recruiting staff member responsible for their respective event of the availability of any marketing materials. The marketing materials are also posted to the candidate web site.

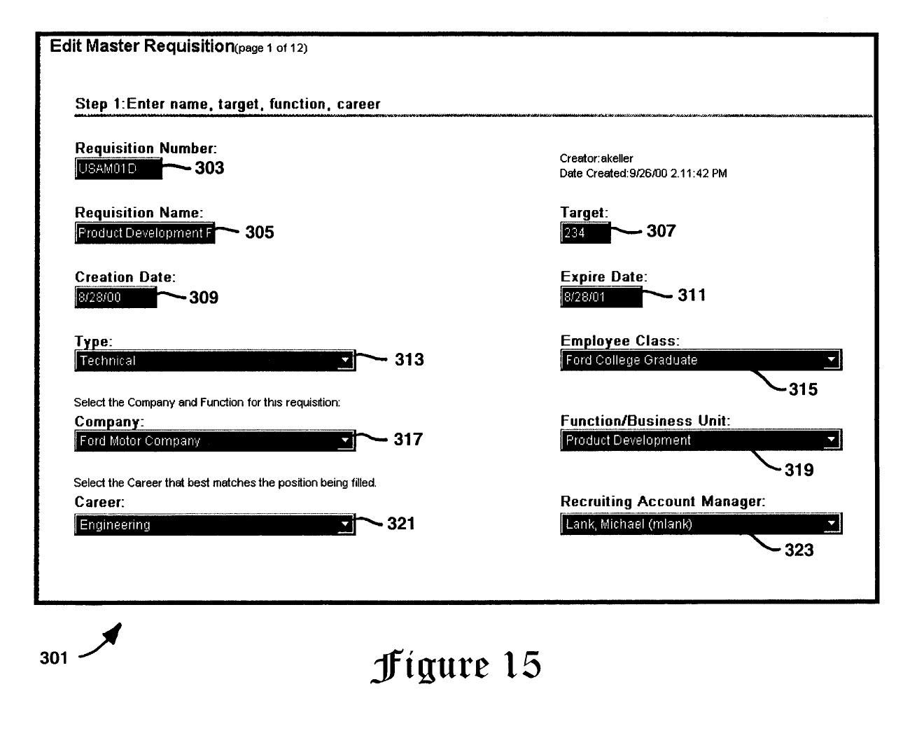

FIGS. 15 through 26 illustrate a series of System interfaces through which recruiting administration defines employment requisitions. Generally, the definition of an employment requisition is an eleven step process. Notably, neither all steps nor any particular order is required for defining an employment requisition.

FIG. 15 illustrates a System interface 301 for defining general attributes of an employment requisition. General attributes comprise a requisition number 303, a requisition name 305, a target number of hires for the requisition 307, a creation date 309, an expiration date 311, a type (e.g., technical, business, etc. 313), an employee class 315 (e.g., co-op, intern, direct hire, etc.), the name of the employer 317, the function or business unit of the employer 319 (e.g., product development, engineering, sales, etc.) the general career type 321 and a recruiting manager for the requisition 323.

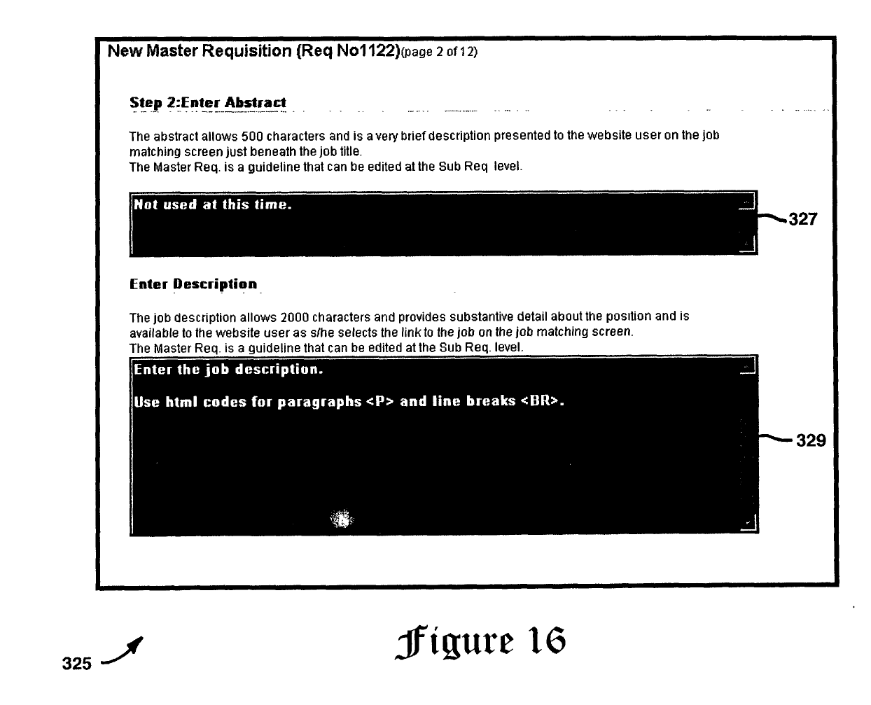

FIG. 16 illustrates a System interface 325 for defining an abstract 327 and detailed description 329 for the employment requisition.

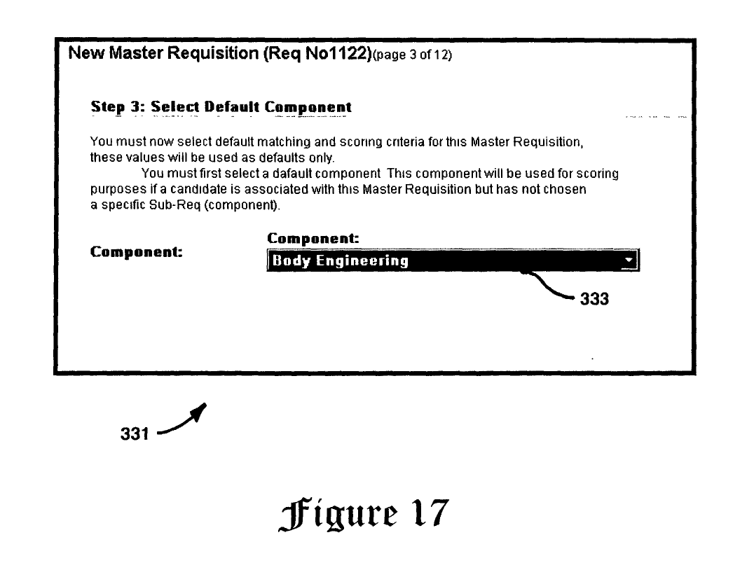

FIG. 17 illustrates a System interface 331 for selecting default candidate matching components 333 for the employment requisition. Preferably, the default component pull-down menu comprises a complete list of the employer's business departments.

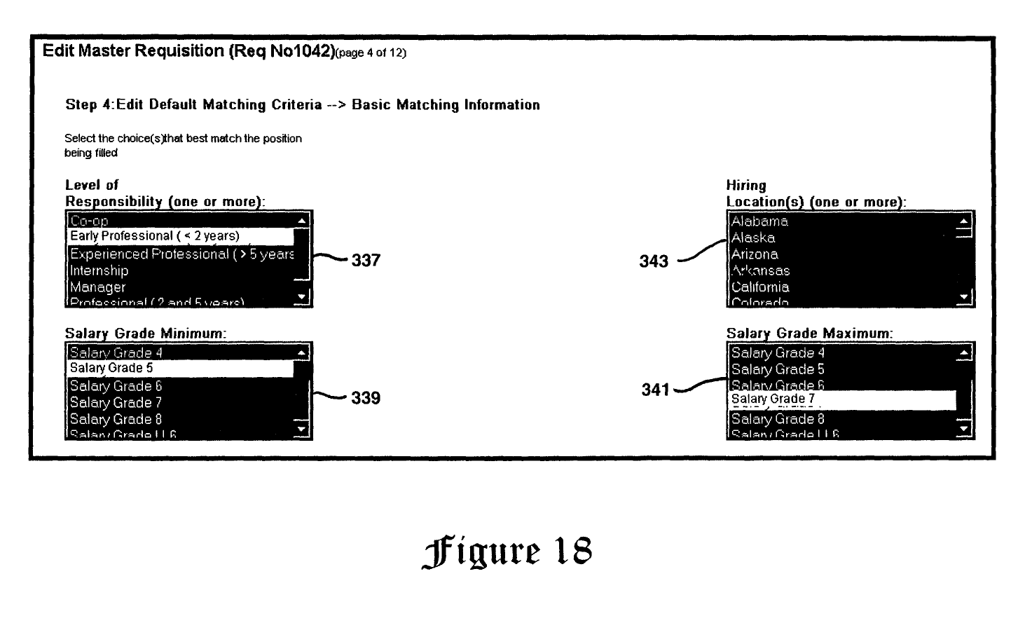

FIG. 18 illustrates a System interface 335 for defining basic candidate matching information for the employment requisition. Basic candidate matching information includes but is not limited to the level(s) of responsibility the employment opportunity demands 337, the minimum salary for the position 339, the maximum salary for the position 341 and the location(s) 343.

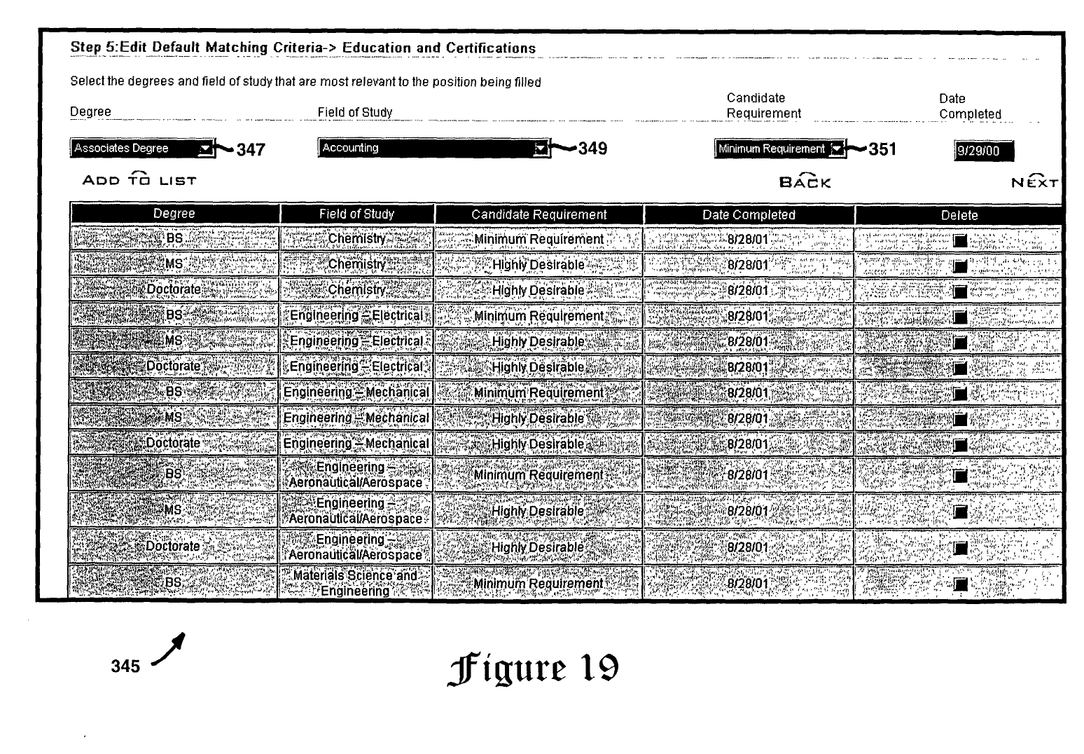

FIG. 19 illustrates a System interface 345 for defining a candidate's education required for the employment requisition. Education and certification requirements include but are not limited to a degree type 347, a field of study 349 and a candidate requirement (e.g., highly desirable, desirable, minimum requirement, etc.) 351.

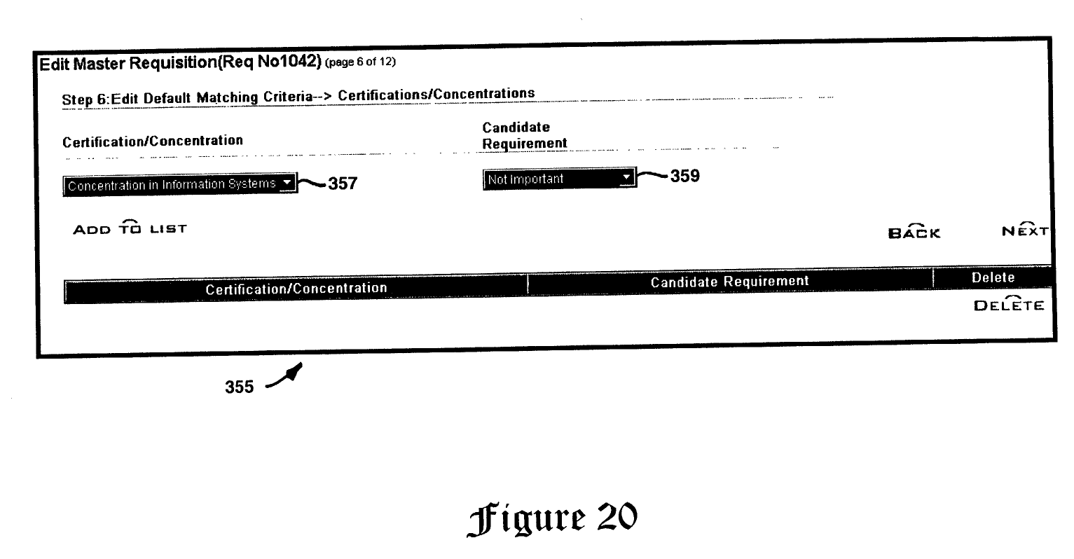

FIG. 20 illustrates a System interface 355 for defining certifications and concentrations 357 and corresponding candidate requirements 359 (e.g., not important, very important, etc.) for the employment requisition.

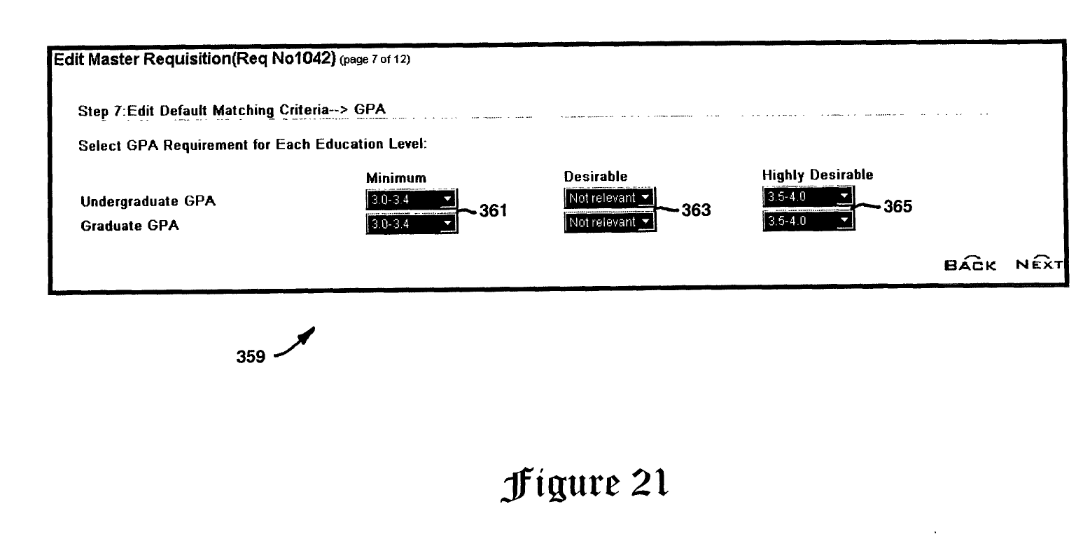

FIG. 21 illustrates a System interface 359 for defining the minimum 361, desirable 363 and highly desirable 365 candidate grade point averages for the employment requisition.

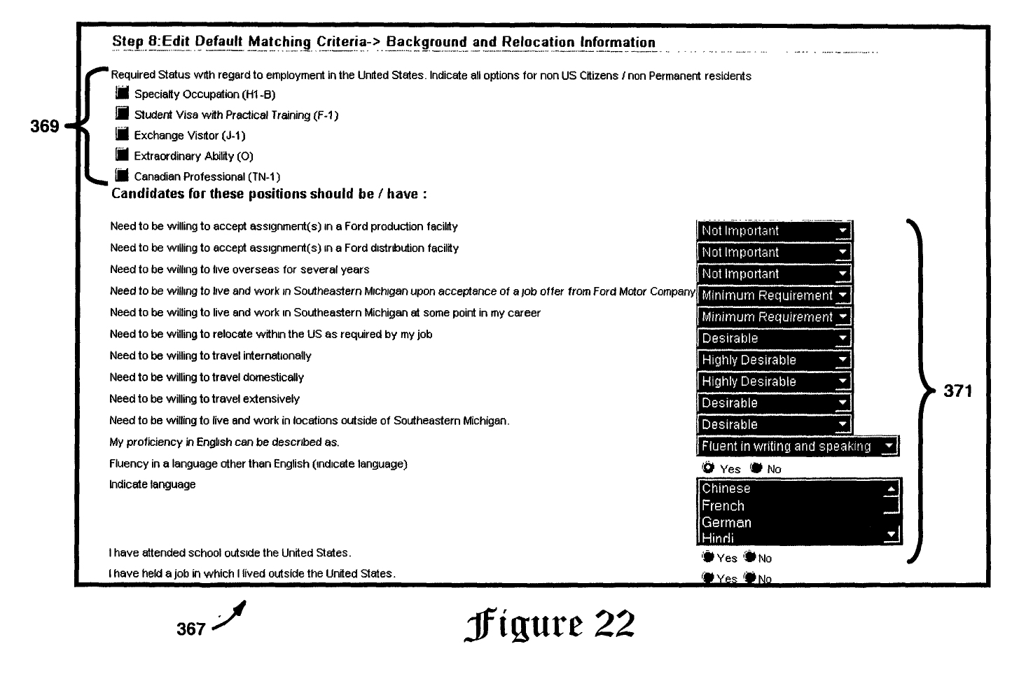

FIG. 22 illustrates a System interface 367 for defining candidate background information 369 and candidate relocation preference information 371.

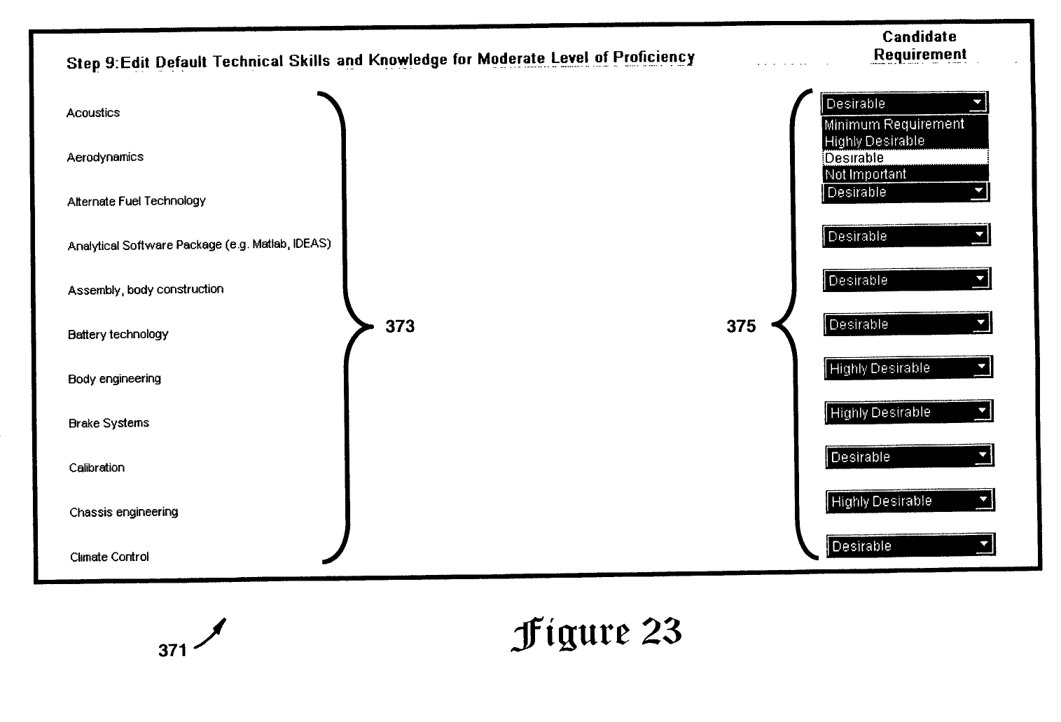

FIG. 23 illustrates a System interface 371 for defining the required technical skills and knowledge 373 at a moderate proficiency level and corresponding requirement levels 375 (e.g., desirable, non-desirable and N/A) associated with the employment requisition.

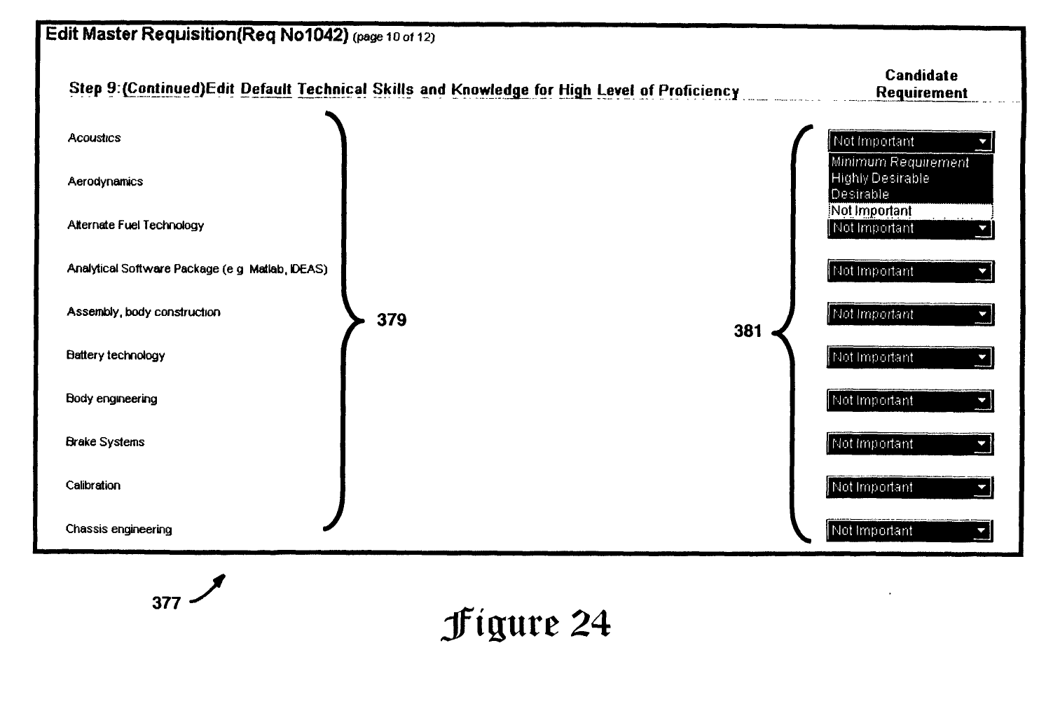

FIG. 24 illustrates a System interface 377 for defining the required technical skills and knowledge 379 at a high proficiency level and corresponding requirement levels 381 (e.g., desirable, non-desirable and N/A) associated with the employment requisition.

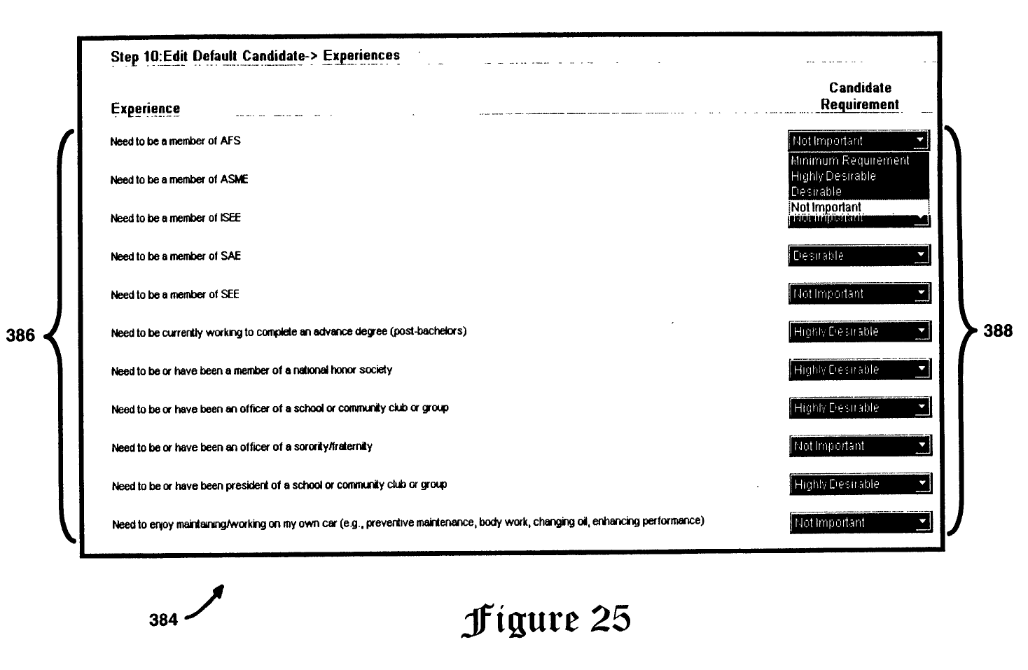

FIG. 25 illustrates a System interface 384 for defining the candidate experiences 386 required for the employment requisition and corresponding requirement levels 388 (e.g., minimum requirement, highly desirable, desirable, not important).

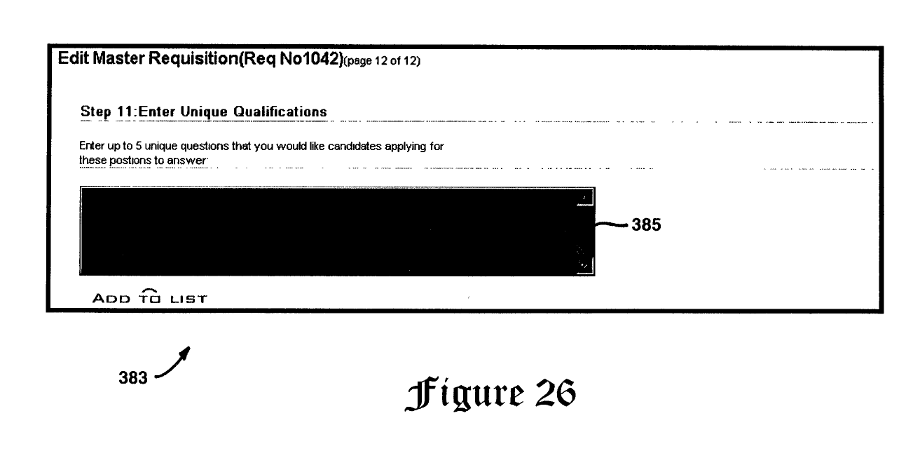

FIG. 26 illustrates a System interface 383 for defining any additional unique qualifications 385 required for or associated with the employment requisition.

After the employment requisitions are input into the System and stored within an employment requisition database (not shown), they are revised, approved and posted on the candidate web site, as discussed infra. Additionally, the employment opportunities may be posted to other Internet-based career finder sites or bulletin boards.

Preferably, the database of defined employment requisitions can be searched according to search criteria comprising requisition name, number, creator, function, career, event type and creation date.

### Candidate Identification

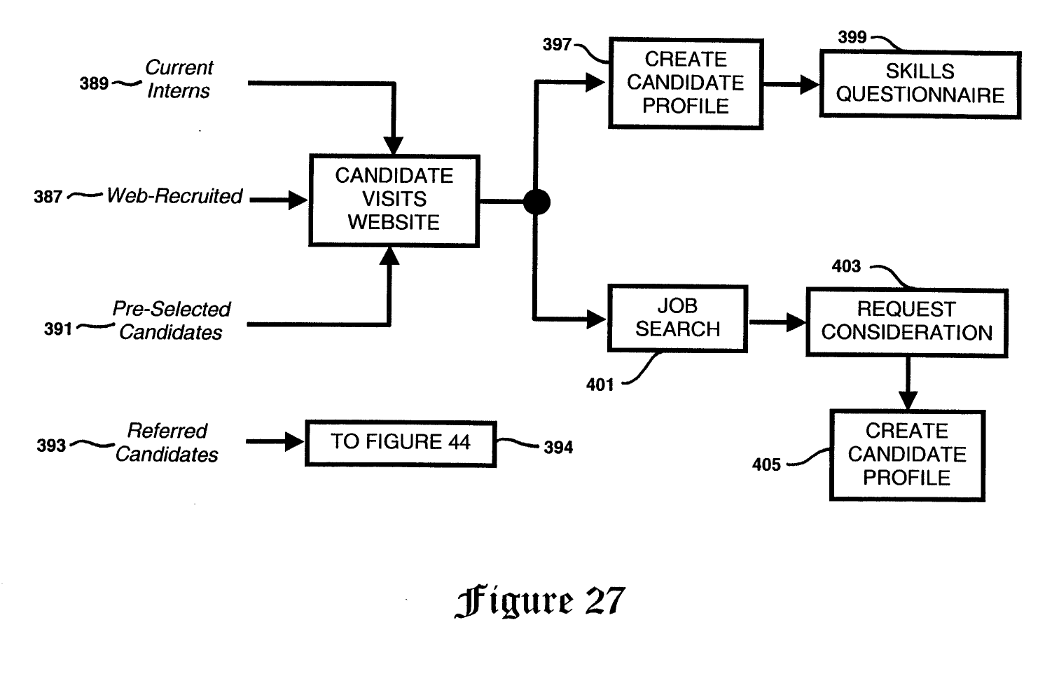

Candidate identification is an ongoing step in which candidates for employment are first identified. FIG. 27 is a block flow diagram illustrating an overview of the candidate identification process. Generally, there are four types of candidates: candidates who have participated in the hiring process primarily through the candidate web site discussed infra (“web candidates” 387), current interns 389 preselected candidates 391 (e.g., agency conversions) and referred candidates 393.

Preselected candidates 391 and current interns 389 are encouraged by their respective recruiters and supervisors to access the candidate web site 395 discussed infra. All candidates accessing the candidate web site for the first time have the option of creating a personal profile 397 and thereafter completing an employment skills questionnaire 399, or searching posted employment opportunities 401. Candidates who request consideration for searched employment opportunity 403 must also complete a personal profile 405.

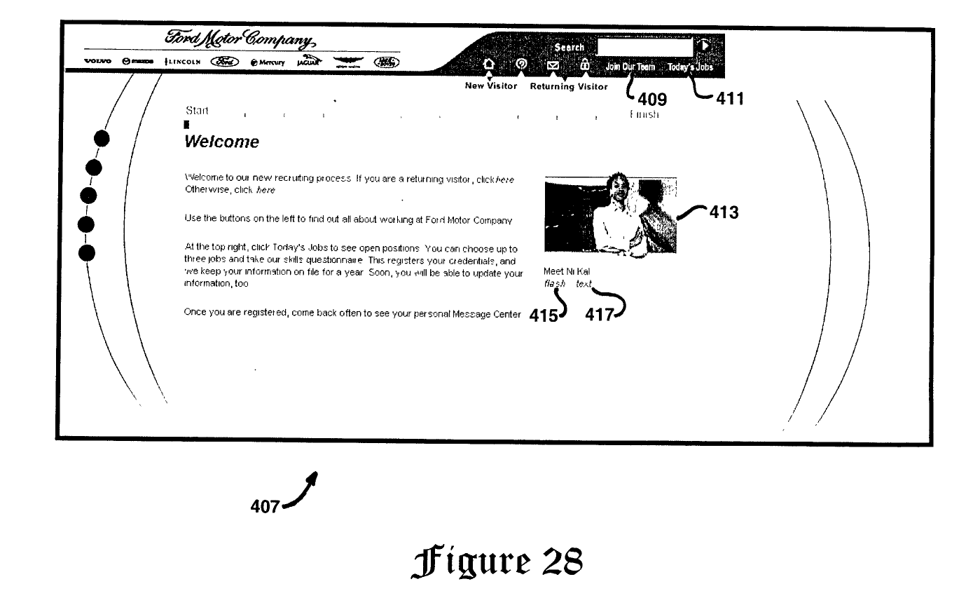

FIGS. 28 through 43 illustrate the candidate web site. FIG. 28 illustrates an introductory page 407 at the candidate web site. At the introductory page, the candidate has the option of selecting the “Join Our Team” hyperlink 409 to create a personal profile and thereafter complete an on-line skills questionnaire, or selecting the “Today's Jobs” hyperlink 411 to search and request consideration for posted employment opportunities.

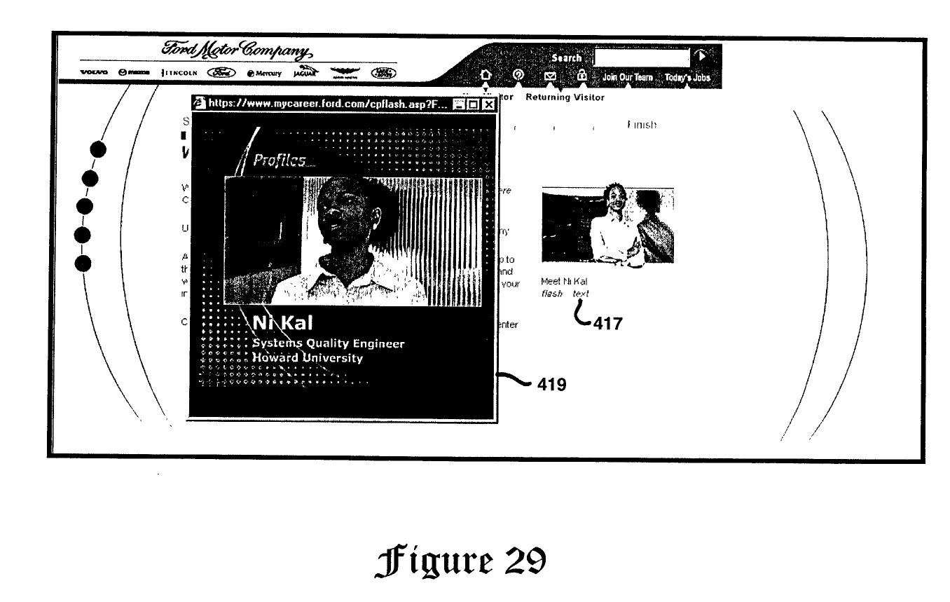

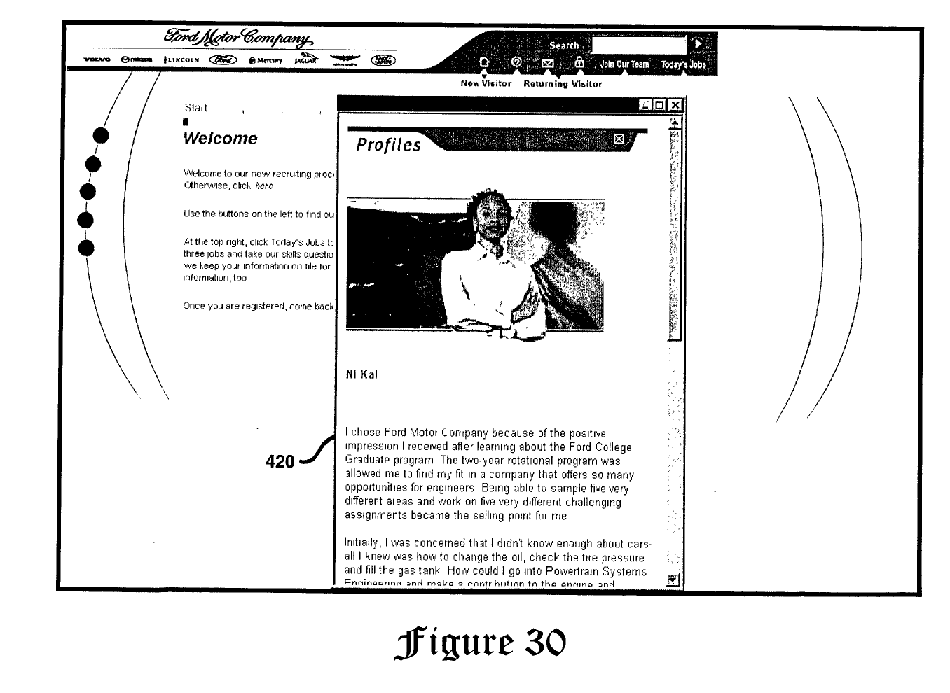

Notably, the candidate is presented with an image of a certified recruiter or event staff member (e.g., Ni Kal) 413 having associated “Flashy™” 415 and “text” 417 hyperlinks. Upon selecting the “Flashy” hyperlink, a new browser window 419 is spawned as illustrated in FIG. 29. The new browser window presents the candidate with a Flash™ presentation (e.g., streaming graphics, animation and audio) of the certified recruiter's biography. Alternately, the candidate can select the “text” hyperlink 417 and be presented with a non-Flash (i.e., HTML-based) presentation of the recruiter's biography 420 as illustrated in FIG. 30.

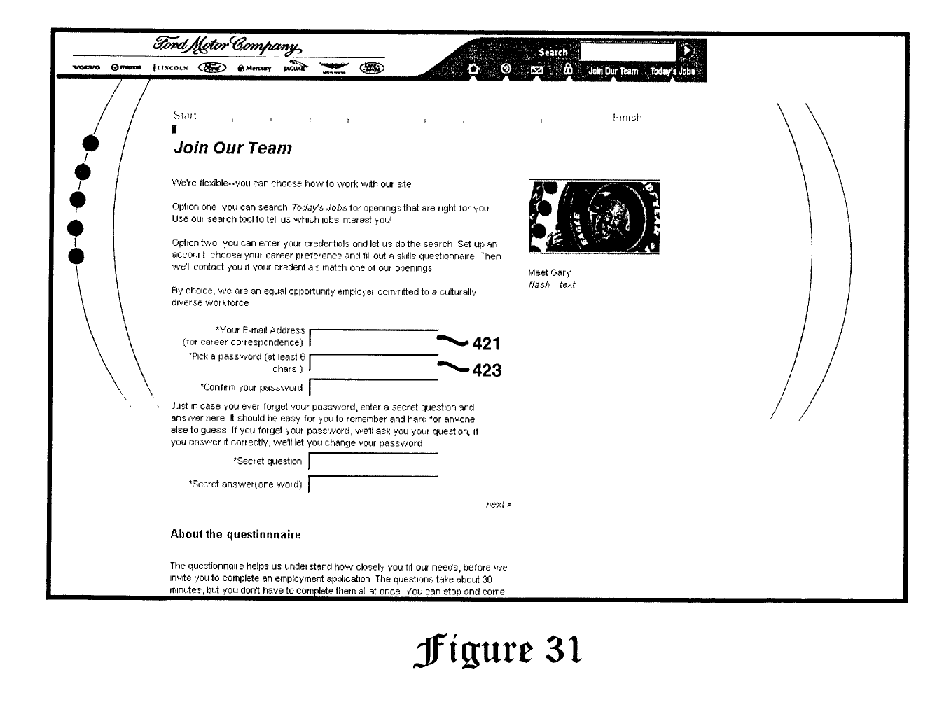

Candidates selecting the “Join Our Team” hyperlink 409 at the introductory page illustrated in FIG. 28 are presented with the page illustrated in FIG. 31. FIG. 31 illustrates the first page for creating a candidate's personal profile Here, the candidate enters her e-mail address 421 and password 423 for future access to the candidate web site.

Upon entering her e-mail address and password for the first time, the System creates a profile for the candidate that is stored and accessible to hiring administration and staff behind the public-access firewall 35a illustrated in FIG. 2. As discussed in more detail infra, the candidate profile is updated during the remainder of the hiring process based on candidate input and input from recruiters and event staff.

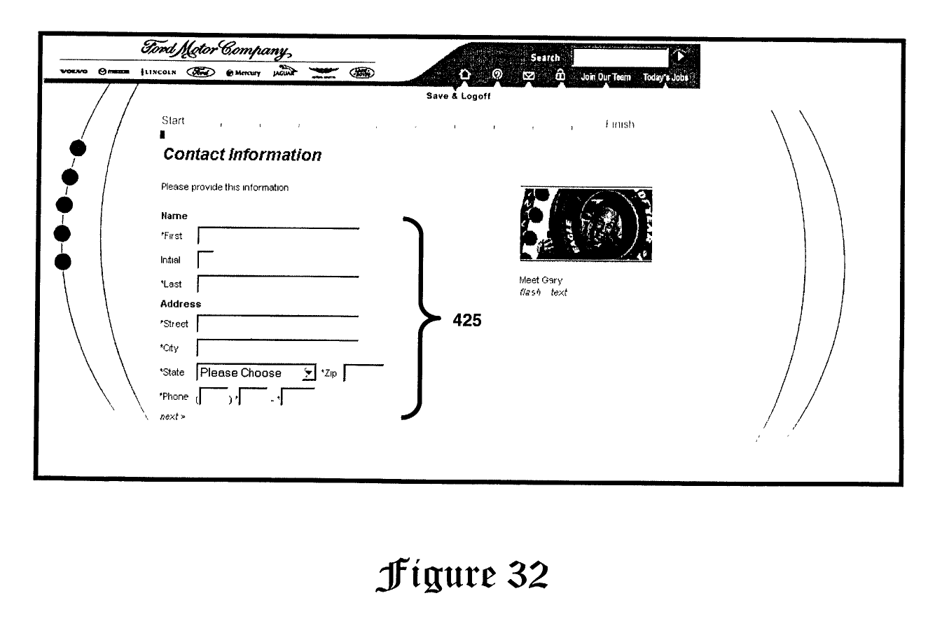

After entering her e-mail address and password for the first time, the candidate is presented with the “Contact Information” page illustrated in FIG. 32. Here, the candidate inputs her current contact information (e.g., name, address, telephone number etc.) 425. Automatically, the system adds the candidate's contact information to her profile behind the public-access firewall 35a illustrated in FIG. 2.

Notably, the System retains and updates all information that the candidate inputs during the hiring process. Accordingly, the candidate does not have to enter the same information into the System more than once over the course of the hiring process.

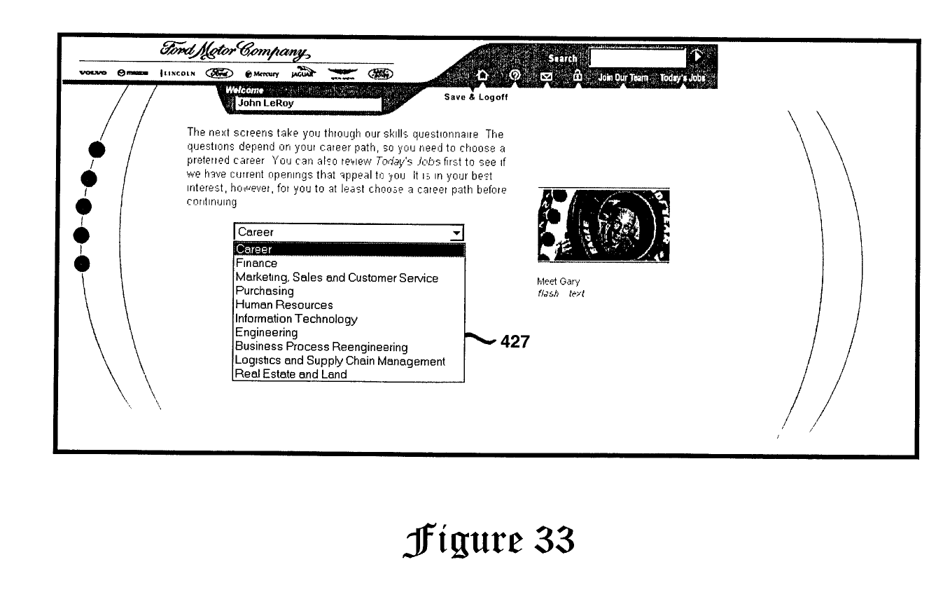

FIG. 33 illustrates the beginning of the on-line skills questionnaire. To begin the questionnaire, the candidate selects a career path from a career path drop-down menu 427. Preferably, skills questionnaire content depends on the career path chosen by the candidate. As discussed infra, the candidate's responses to the skills questionnaire are added to the candidates' profile and reviewed during the candidate invitation step of the hiring process to decide whether to invite the selected candidate to an employer-hosted event for further evaluation.

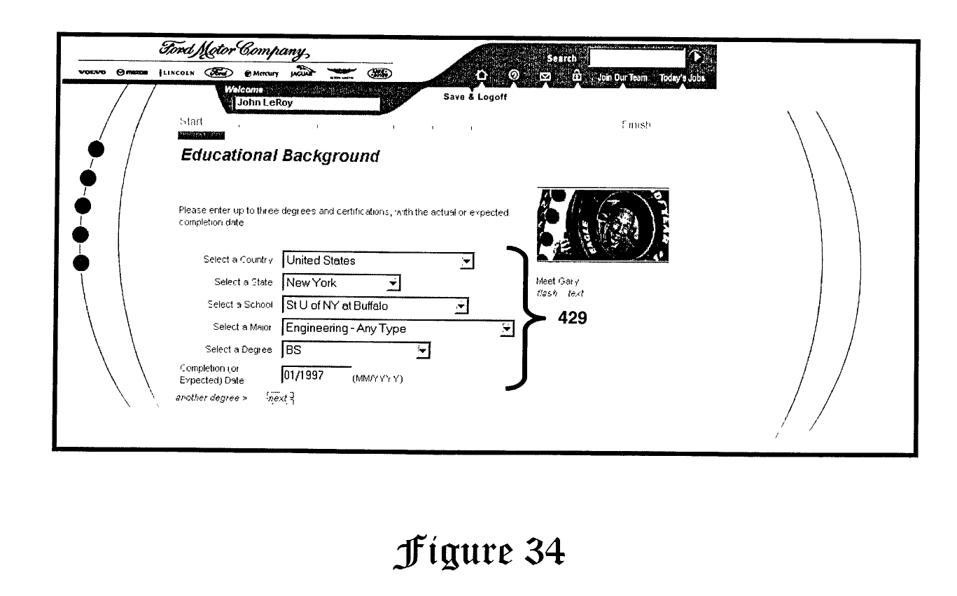

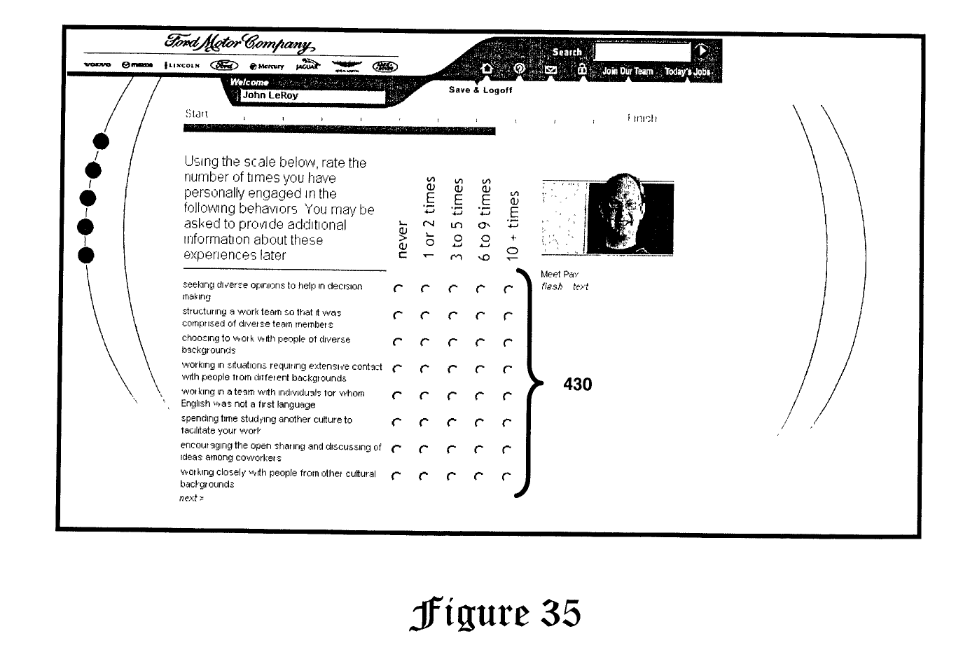

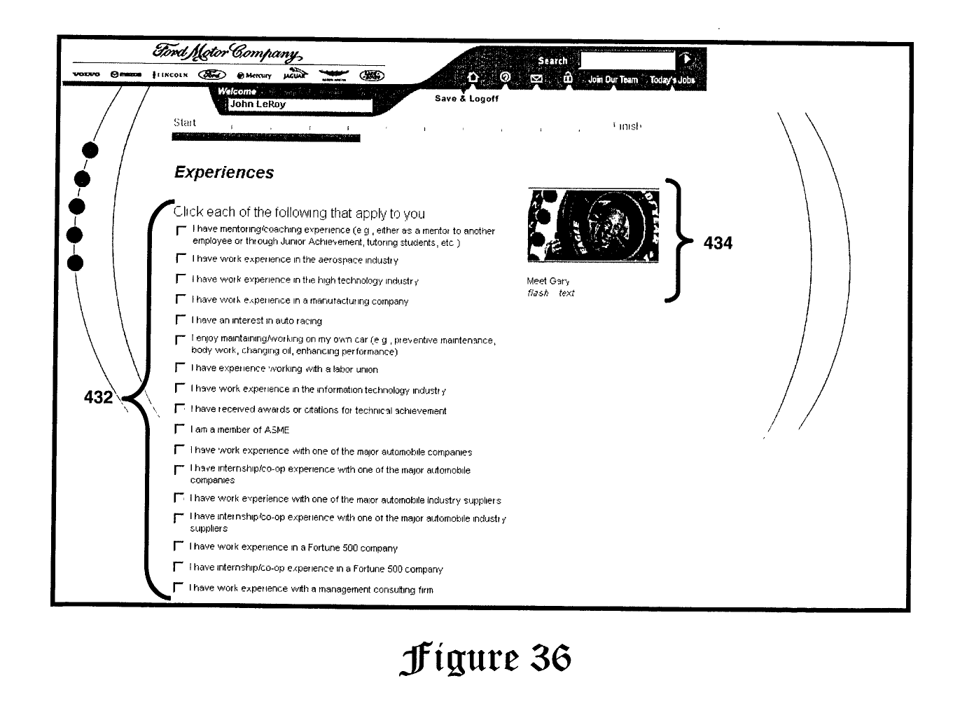

Skills questionnaire inquiries include but are not limited to the candidate's educational background 429 as illustrated in FIG. 34 a leadership behavior assessment 430 as illustrated in FIG. 35, personal experiences 432 as illustrated in FIG. 36, a minimum salary requirement, an employment history and a personal evaluation. Preferably, current intern candidates are presented with additional inquiries regarding their personal intern experience.

Notably, the recruiter biographies 434 presented at the candidate web site begin to track the candidate's updated profile where possible. For example, the biography of a recruiter currently working for the employer as an electrical engineer my be presented to candidates whose profile indicates an interest or experience in electrical engineering. As a result of having recruiter biographies that automatically track the candidates' profiles, the candidates can learn more about and potentially meet certified recruiters with whom the candidates have something in common.

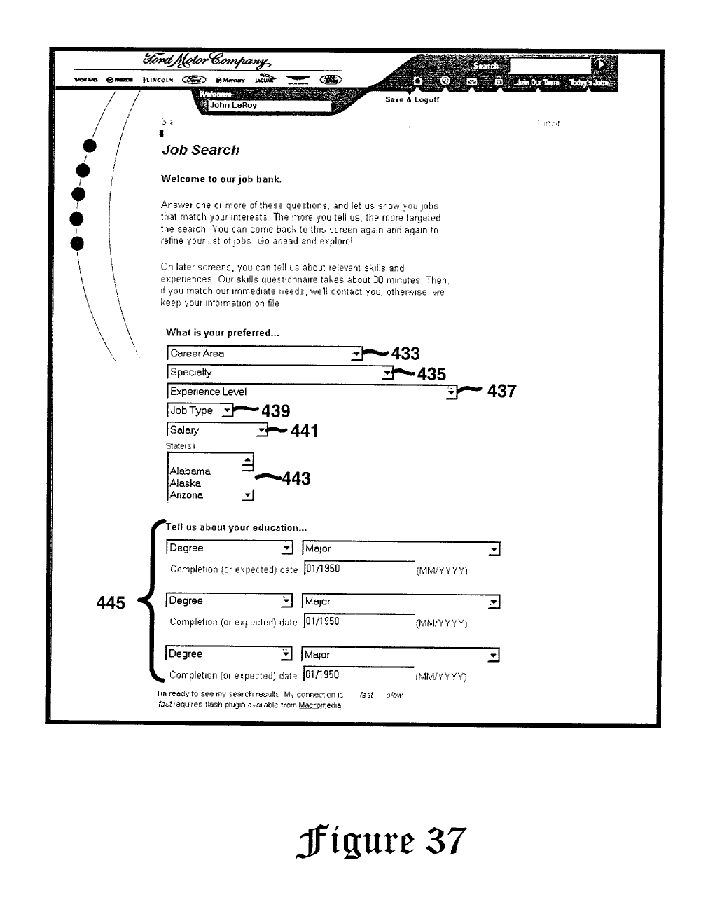

Candidates who choose to search available employment opportunities select the “Today's Jobs” hyperlink 411 (illustrated in FIG. 28) and are presented with the “Job Search” page illustrated in FIG. 37. Here, the candidate inputs her employment preferences (e.g., career area 433, specialty 435, experience 437, job type 439, salary 441, location 443, etc.) and her educational background 445.

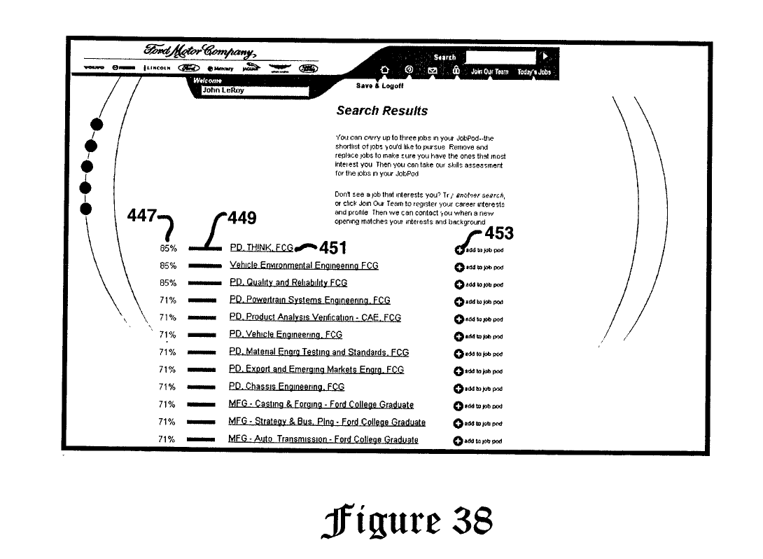

After submitting her search, the candidate is presented with the “Search Results” page illustrated in FIG. 38. Each search result comprises a percent match value 447, a percent match graphical indicator 449, a job description hyperlink 451 and an “Add to job pod” button 453. Preferably, the search results are listed in descending order according to the percent that the candidate matching criteria specified in the employment requisition matches the candidate's employment preferences and educational background.

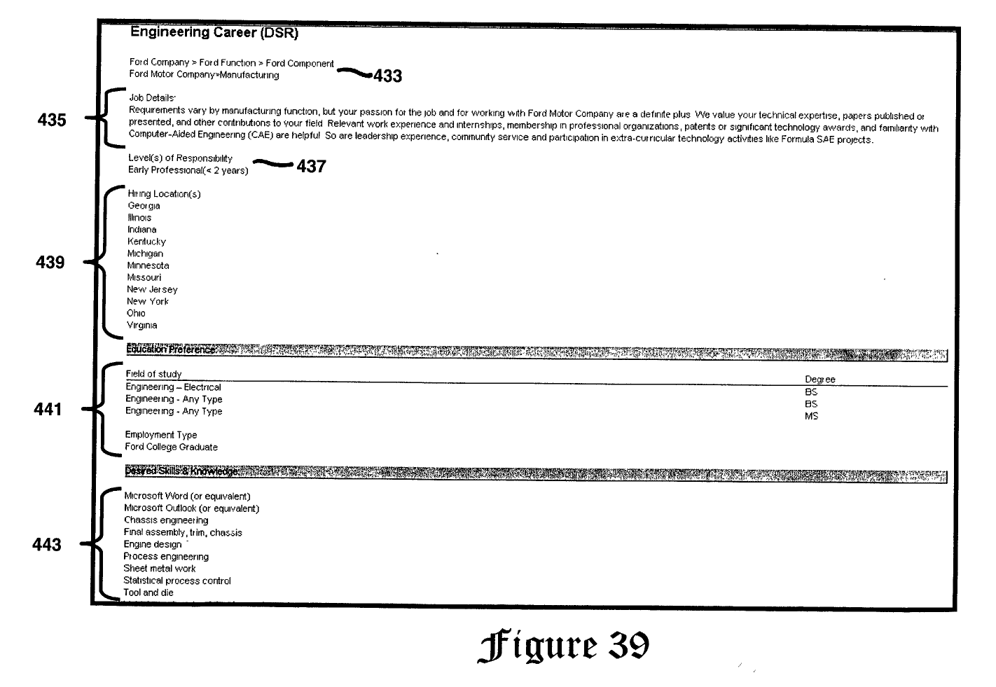

For a more detailed description of a particular search result, the candidate selects the job description hyperlink 431 for a selected employment opportunity. FIG. 39 illustrates a web page containing a detailed job description. A detailed job description comprises the department or function to which the employment opportunity applies 433, details of the employment opportunity 435, levels of responsibility 437, hiring locations 439, education preference 441 and desired skills and knowledge 443.

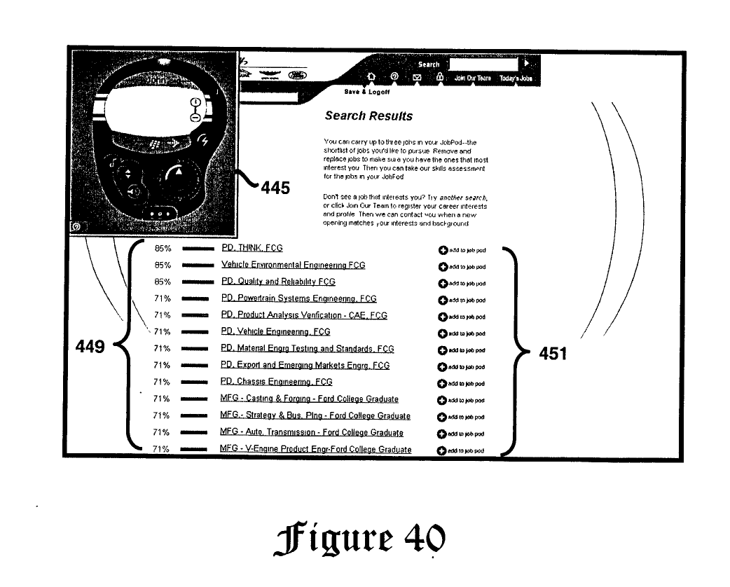

Upon selecting the “Add to job pod” button 453 illustrated in FIG. 38, a new browser window 445 containing a Flash-based job pod 447 is spawned, as illustrated in FIG. 40. Alternately, an HTML-based job pod (not shown) is provided for browsers lacking the appropriate Flash plug-in. The job pod is an interactive multimedia tool that the candidate uses to manage job opportunities the candidate is interested in. Referring again to FIG. 40, searched job opportunities 449 are added or uploaded to the job pod 445 by selecting the “Add to job pod” hyperlink 451 associated with each job opportunity.

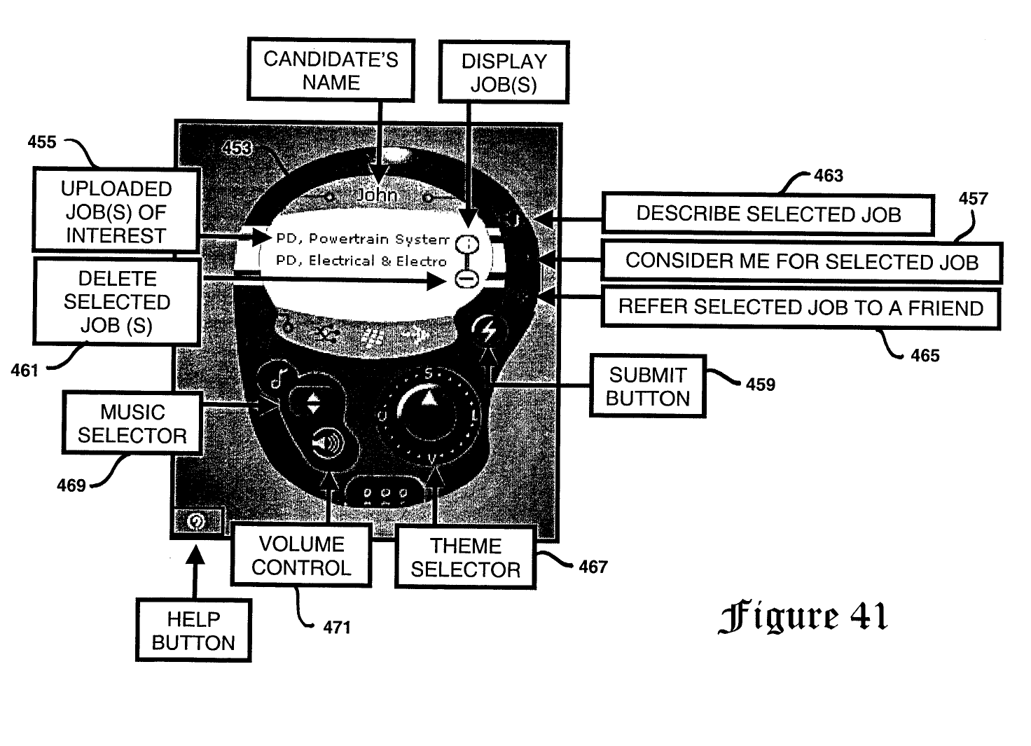

FIG. 41 illustrates various elements of functionality associated with the job pod 453. The principal function of the job pod is to request consideration for an uploaded job opportunity. To do so, the candidate highlights an uploaded job opportunity 455, selects “C” for “Consider Me” 457 and selects the submit button 459. In response, the System adds the candidate to a pool of candidates (the “candidate pool”) that have requested consideration for that particular employment opportunity. As discussed in more detail infra, the profile of each selected candidate in the candidate pool is reviewed during the candidate recommendation step of the hiring process to decide whether to invite the candidate to an employer-hosted recruiting event for further evaluation.

Another function of the job pod is to retain job opportunities uploaded by a candidate during a previous visit to the web site. Each time the candidate logs in at the web site and activates her job pod, her job pod presents the last three uploaded job opportunities.

Functionality is also provided to remove an unwanted job opportunity from the job pod. To do so, the candidate selects or highlights the unwanted job opportunity 455 and selects button 461 to delete the job listing.

The job pod also provides functionality to obtain a detailed job description of added jobs. To obtain a detailed job description, the candidate highlights an added job opportunity 455, selects “J” 463 for “Job Details” and selects the submit button 459. In response, the System presents the candidate with a detailed job description as previously illustrated in FIG. 39.

Yet another function of the job pod is to refer selected job opportunities to a candidate's friend. To do so, the candidate highlights an uploaded job opportunity 455 and selects “R” 465 for “Refer Selected Job to a Friend”. In response, an e-mail application is spawned (not shown) having the job opportunity contained within the main text field of the e-mail. To send the mail, the candidate inputs the e-mail address of the recipient and selects “Send” (not shown).

Additional job pod functionality allows a candidate to customize the job pod. For example, the candidate can operate a themes selector button 467 to redefine the job pod color scheme (e.g., industrial, classical, camouflage, etc.). By operating the music selector 469, the candidate can select and play various types of music (e.g., classical, hip hop, jazz, etc.). The candidate operates the volume control 471 to toggle the volume on or off.

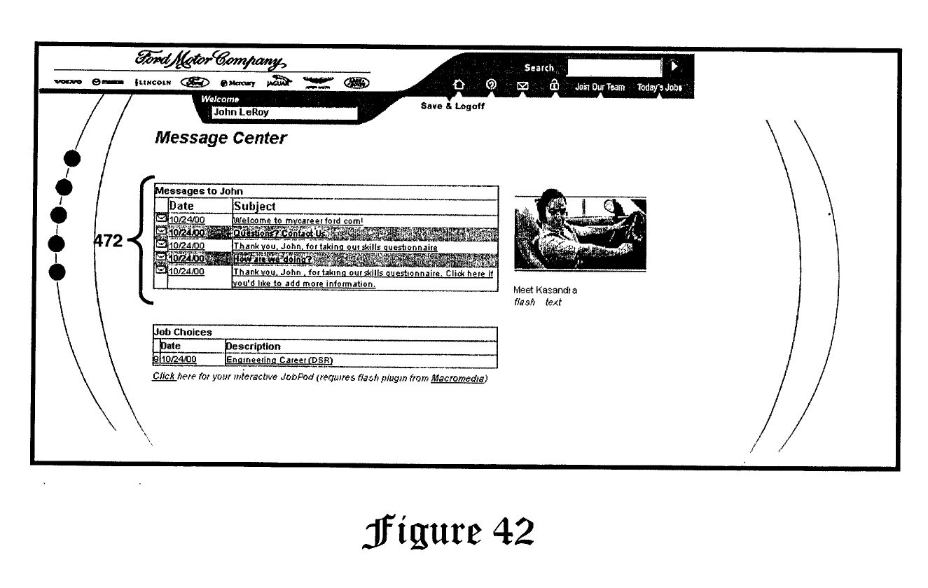

FIG. 42 illustrates a personalized interactive messaging center presented to candidates who have requested consideration for current employment opportunities or taken the on-line skills questionnaire. Upon login to the candidate web site, the candidate utilizes the message center to communicate with recruiters, monitor the candidate's personal status throughout the hiring process and access her job pod. As candidates progress throughout the recruiting process, they receive guidance via the message center in an e-mail format 472. Guidance includes but is not limited to scheduling information, next-step instructions, frequently asked questions. Additionally, candidates can provide feedback to recruiters regarding the recruiting process and present the recruiters with any special needs or questions the candidates may have. Candidates who progress to the final stages of the recruiting process receive invitations to employer-hosted events, hard and soft rejections for employment, and offer/no offer letters via their personalized message center, as discussed infra. Additionally, candidates accepting employment conduct follow-up activities via their respective message centers.

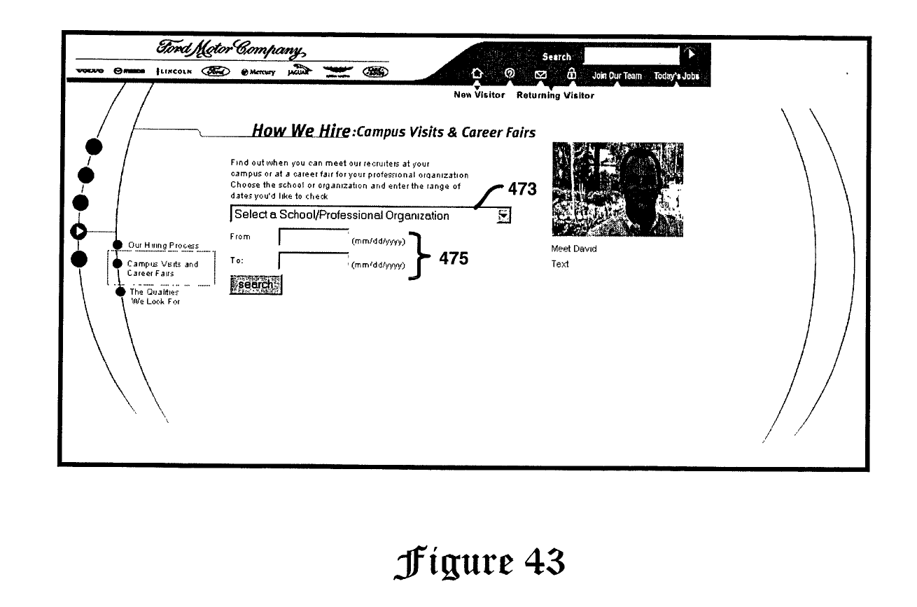

FIG. 43 illustrates a page at the candidate web site for searching the campus visits and career fairs scheduled by recruiters, as discussed in FIG. 13. Candidates can search campus visits and career fairs according to the name of their school/professional organization 473 and date range 475.

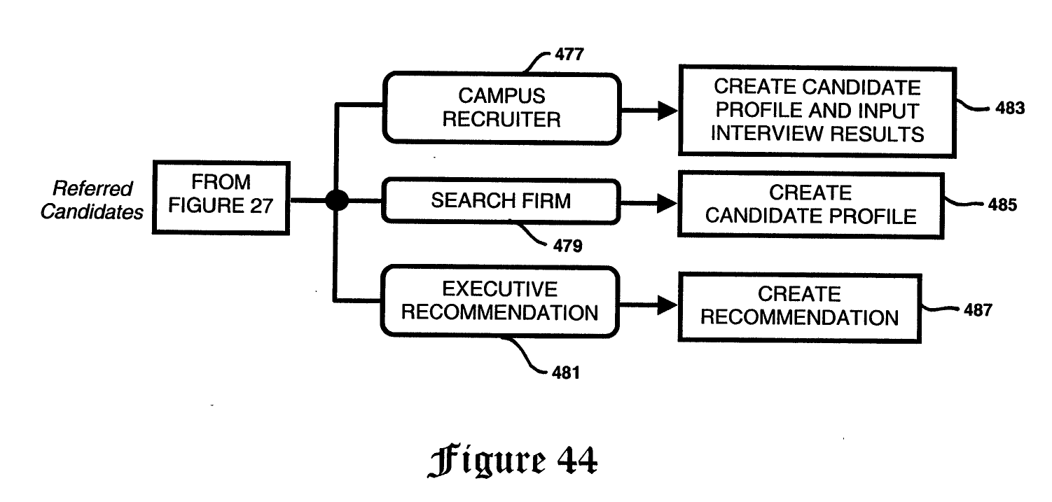

FIG. 44 is a block flow diagram continuing from FIG. 27, block 394 . Unlike the web-recruited candidates discussed in FIG. 27, referred candidates first come in contact with the hiring process through a campus recruiter 477 (e.g., through an on-campus interview), an employee search firm 479 or through an executive recommendation 481.

If the referred candidate was identified by a campus recruiter 477 through an on-campus interview, the recruiter accesses the System behind the public firewall, creates a profile for the candidate and inputs the interview results as shown in block 483.

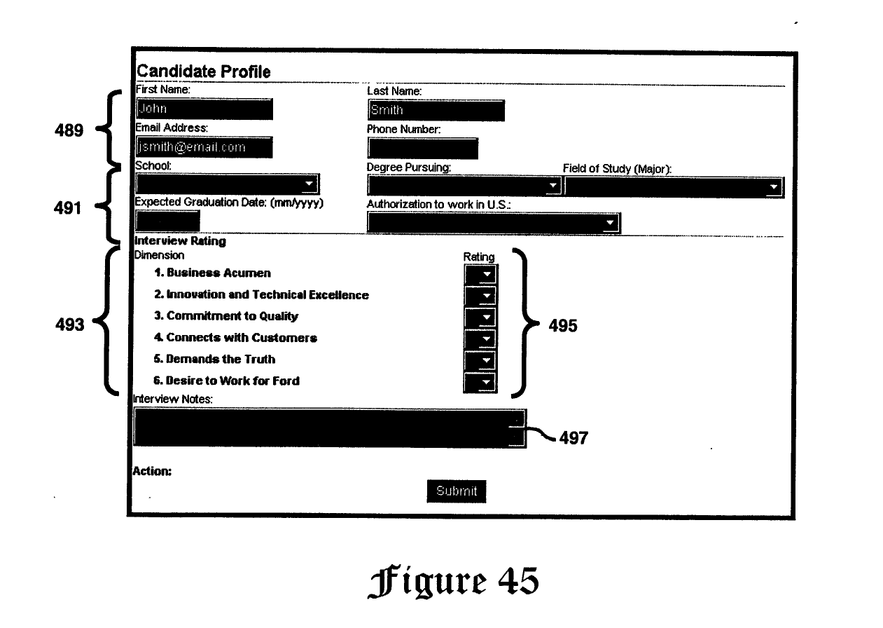

FIG. 45 illustrates a System interface through which a path B recruiter defines the profile and assessment of a candidate identified via an on-campus interview. To define the candidate's profile, the recruiter inputs the candidate's contact information 489 and school information 491. To define the candidate's interview results, the recruiter rates the candidate based on various rating

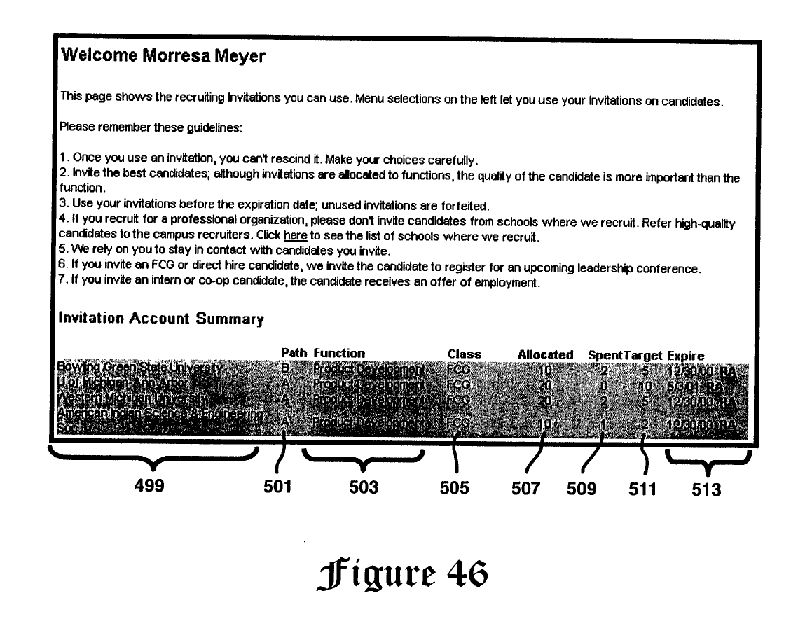

In accord with a preferred embodiment of the present invention, the System hosts a recruiting account for each recruiter to manage candidates and invitations. FIGS. 46 through 49 illustrate a recruiter's on-line recruiting account. FIG. 46 illustrates a recruiter's invitation account summary page. Each invitation set comprises a school or organization name 499, a recruiter type 501, a function 503, a candidate class 505, the number of invitations originally allocated to the recruiter 507, the number of invitations already given out to candidates 509, the recruiter's target number of hires for the invitation criteria 511, and the expiration date of the invitations 513.

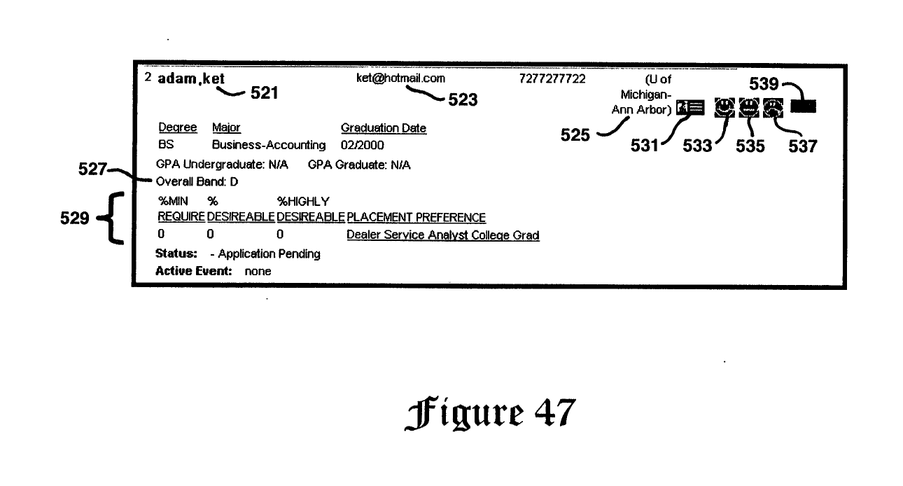

FIG. 47 illustrates an example candidate listing. In accord with a preferred embodiment of the present invention, the candidates listed on each recruiter's candidate listing are those who are attending or who have recently attended a school included in the recruiter's pre-defined invitation criteria (e.g., function and school).

Preferably, a recruiter can narrow the candidate listing to display candidates who have already received an invitation from the recruiter candidates according to the school they attend or candidates distinguished according to the function they have expressed an interest in during their skills questionnaire or job search. Each candidate listing comprises the name of the candidate 521, the candidate's e-mail address 523, the school or organization that the candidate belongs to 525, an overall band for the candidate 527, discussed infra, a candidate match assessment 529, a button 531 for accessing the candidate's profile, a button 533 for sending an invitation e-mail to the candidate's message center, a button 535 for sending a candidate a soft-rejection e-mail (i.e., the candidate has excellent credentials but there is no matching employment opportunity at this time), a button 537 for sending the candidate a hard rejection e-mail (i.e., the candidate does not possess acceptable credentials) and a button 539 for e-mailing the candidate generally.

The candidate band 527 indicates the extent to which the candidate possesses the leadership behaviors required for successful job performance. The band is calculated based on the responses the candidate made to the behavior assessment portion of the candidate skills questionnaire illustrated in FIG. 35.

Quantitatively, the candidate band is based on his or her responses to the behavior assessment inquiries as compared to other candidates' responses. That is, the number of experiences reported by the candidate is standardized against the number of experiences reported by other candidates. This process allows the leadership behavior assessment portion of the skills questionnaire to provide a view of the candidate's job-relevant background and experiences as they compare to the remainder of the applicant pool. Results are provided in three different “bands.” Each band (e.g., A-D) contains candidates that have similar levels of prior experience related to the leadership behaviors required for job success.

Assessment results are an indication of how closely a candidate's, skills and experiences match the employment requisition candidate matching criteria for a job opportunity for which the candidate has requested consideration. Therefore, only candidates who have requested consideration for current job opportunities and have completed the on-line skills questionnaire have assessment results in their profile.

Generally, assessment results comprise “% Minimum Required”, “% Desirable” and “% Highly Desirable”. % Minimum Required indicates the percentage of the candidate's experience and skills that meet or exceed the minimum requirements for the job, as defined in the employment requisition. % Desirable indicates the percentage of the candidate's experience and skills that meet or exceed the desired requirements for the job. % Highly Desirable indicates the percentage of the candidate's experience and skills that meet or exceed the highly desired requirements for the job.

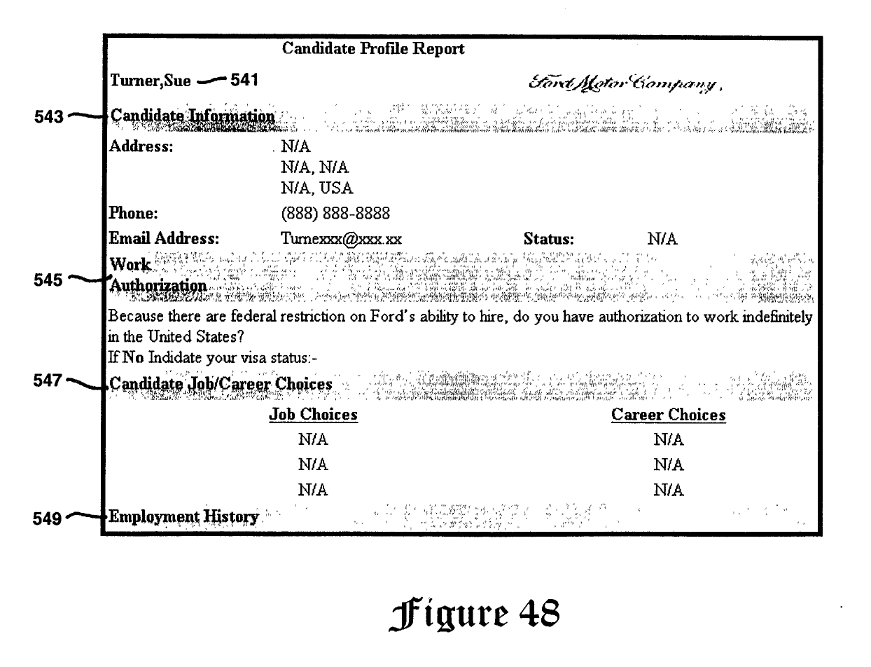

FIG. 48 illustrates a candidate's profile report accessible to recruiters behind the public-access firewall 35b illustrated in FIG. 2. A candidate's profile report comprises the candidate's name 541, contact information 543, work authorization 545, candidate job/career choices 547, employment history 549, candidate band and assessment results (not shown).

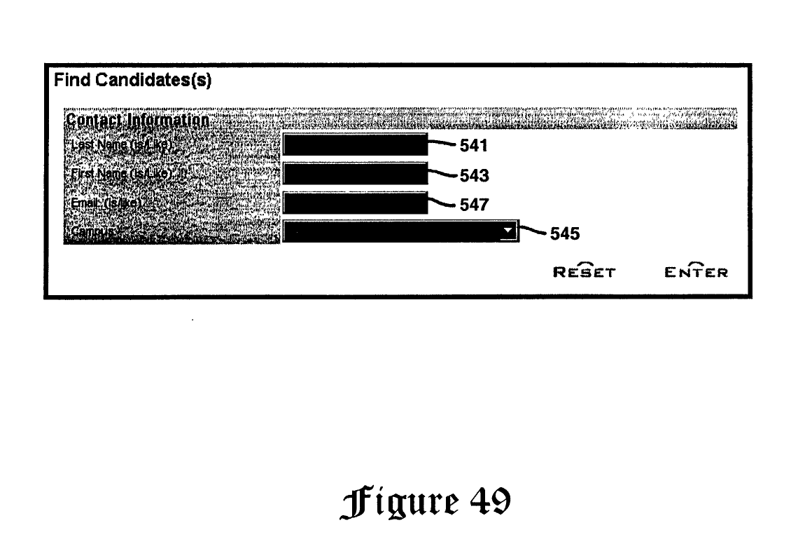

FIG. 49 illustrates a recruiter's candidate search page. Recruiters can search candidates according to last name 551, first name 553, e-mail address 555 and campus 557.

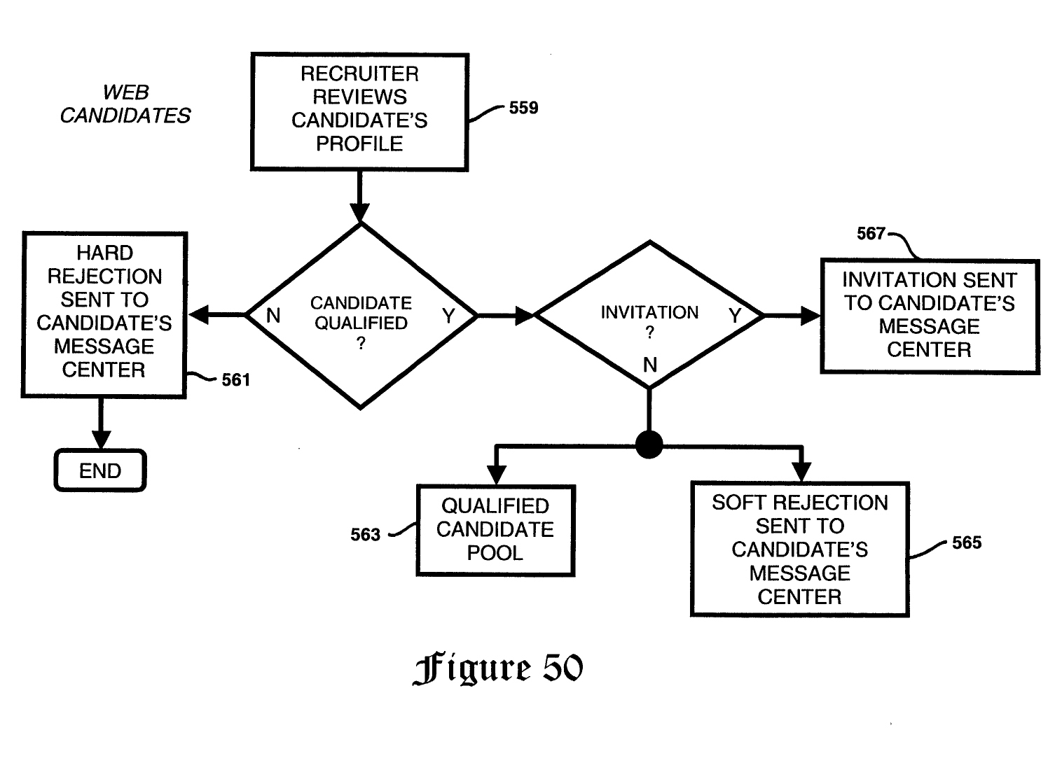

FIG. 50 is a block flow diagram illustrating a recruiter's evaluation-invitation process for Web-recruited candidates who have completed a skills questionnaire. As illustrated in block 559, the recruiter accesses his recruiting account within the System and reviews his candidates' profiles. The recruiter e-mails a hard rejection 561 to any candidates who are not qualified for employment (i.e., their overall band and/or matching criteria falls below an acceptable level). Candidates receive their rejections via their respective message centers.

After reviewing and comparing the remaining candidates, the recruiter distributes his event invitations among the candidates best qualified for the employment opportunities the recruiter has been assigned to fill as described in block 567. Candidates who are not assigned invitations are either added to a pool of candidates as described in block 563 who have requested consideration for a current job opportunity or softly rejected for employment as described in block 565.

A soft rejection is given to candidates who possess impressive credentials, but for whom there are no current employment opportunities that sufficiently match the candidates' particular profile. Preferably, the profiles of candidates who are given a soft rejection are retained within the System for future consideration (i.e., in the following year).

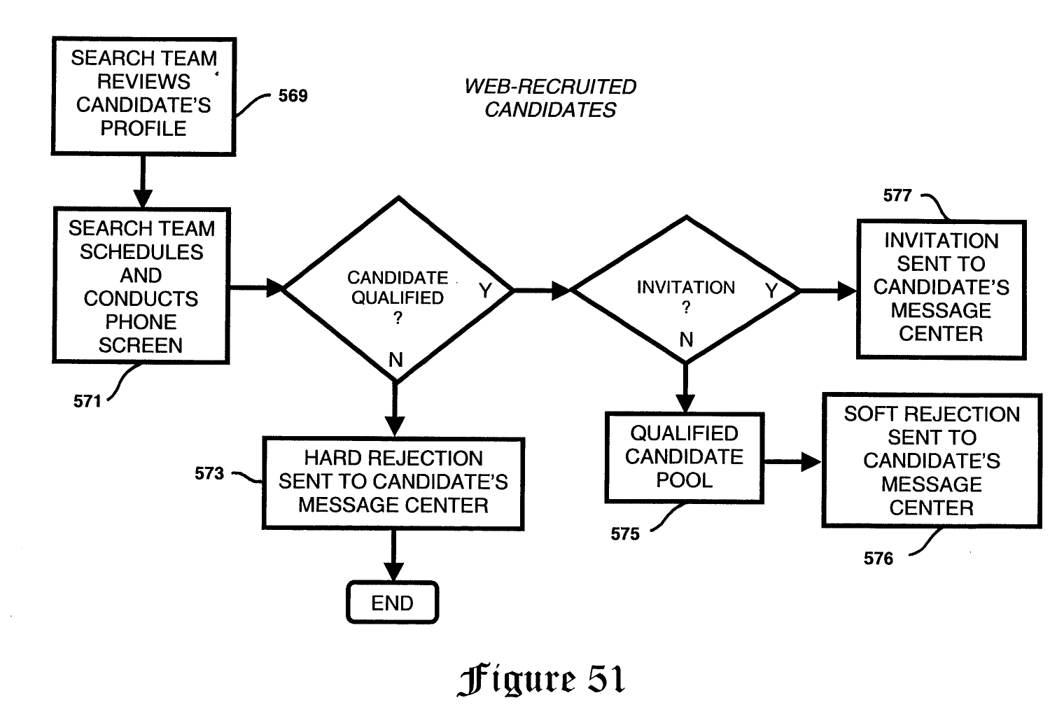

FIG. 51 is a block flow diagram illustrating the search team evaluation-invitation process for job pool candidates. The search team first accesses the System and reviews the candidate profiles as described in block 569. After the qualified candidates are identified, search teams conduct a phone screen 571 with the candidates to assess eligibility, interest and qualifications for employment. Based on the phone screen, the search team sends a hard rejection 573 to any candidates who are not qualified for employment (i.e., their overall band or matching criteria is below an acceptable level). The unqualified candidates receive the rejection via their message centers, as discussed supra. After reviewing and comparing the remaining candidates, the search team distributes event invitations among the candidates best qualified for the employment opportunities the search team has been assigned to fill. Candidates who are not assigned invitations are either added to a pool of candidates who have requested consideration for a current job opportunity 575 or softly rejected for employment 576.

Referred candidates (not shown) are invited to visit the web site to take the web assessment and request consideration for available employment opportunities. Referred candidates are reviewed by the search team using the on-line candidate profile to determine whether the candidates are qualified for employment. Unqualified candidates receive a hard rejection. Event invitations are distributed among the remaining candidates that are best qualified for the available employment opportunities. Candidates who are not assigned invitations are either added to a pool of candidates who have requested consideration for a current job opportunity or softly rejected for employment.

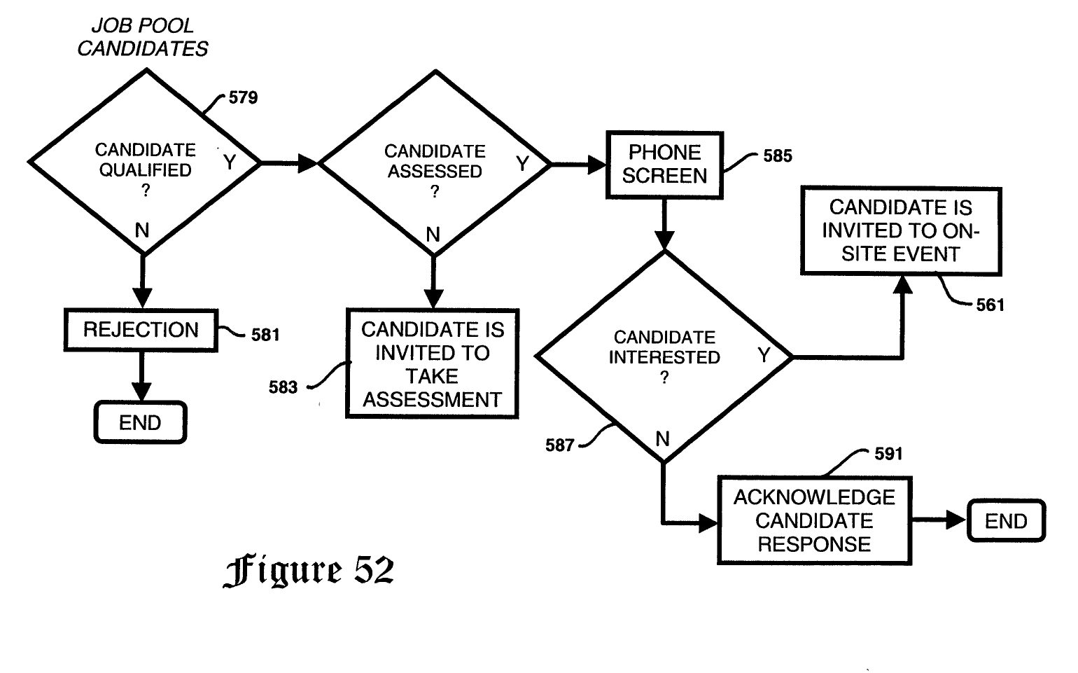

FIG. 52 illustrates a recruiter's evaluation-invitation process for job pool candidates that have requested consideration for current job opportunities. Job pool candidates are recruited by a search team who reviews the on-line profiles of each candidate within the pool to determine whether the candidates are qualified for employment as described in block 579. Candidates who are not qualified for employment are given a hard or soft rejection as described in block 581, depending on the candidates' credentials. Qualified candidates who have not taken the on-line skills questionnaire are invited to do so via e-mail as described in block 583. Qualified candidates who have taken the skills questionnaire are contacted by the search team for a phone screen as described in block 585 to determine whether the candidate is interested in an invitation to an employer-hosted recruiting event. If the candidate is interested, the candidate is given an invitation to an event as described in block 589. If the candidate is not interested, the candidate's response is acknowledged as described in block 591.

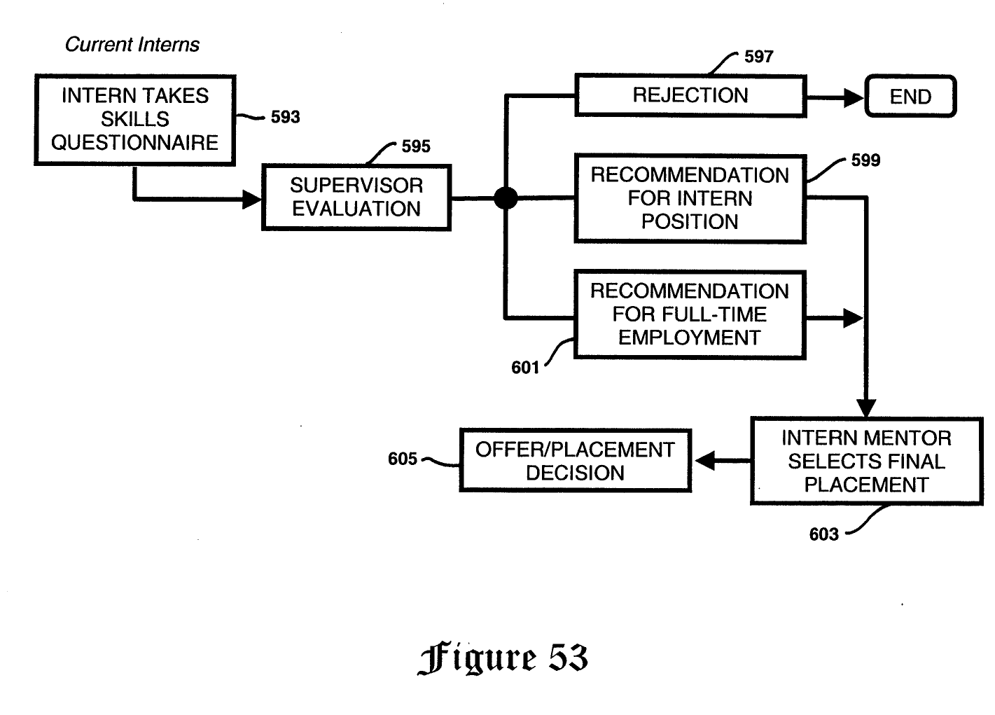

FIG. 53 illustrates an evaluation process for current interns. Current interns are not invited to an event for further evaluation. After the intern has completed her on-line skills assessment as described in block 593, the intern's supervisor evaluates her past job performance as described in block 595. Based on the evaluation, the supervisor has three alternatives. If the supervisor feels the candidate is unacceptable for future employment, the supervisor can access the System and sends a rejection to the intern as described in block 597. If the supervisor feels the intern is suited for further employment and the intern is still in school, the supervisor can access the System and recommend that the intern be invited to return for another internship as described in block 599. If the supervisor feels the intern is suited for further employment and the intern has completed school, the supervisor can access the System and recommend that the intern be hired for full-time employment as described in block 601. Preferably, the intern's current mentor selects final placement for the intern 603 before an offer/placement decision is made as described in block 605.

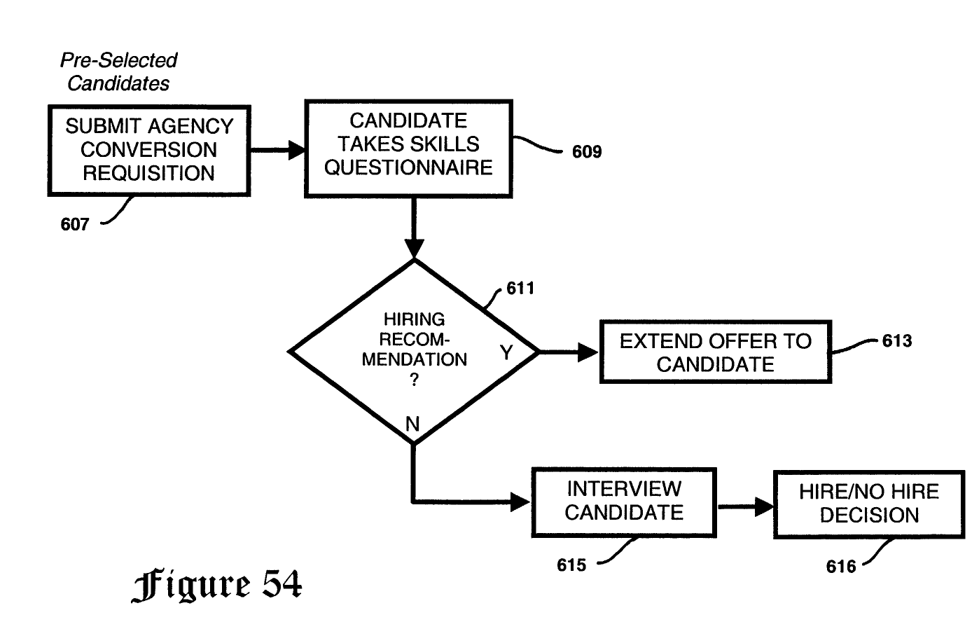

FIG. 54 is a block flow diagram illustrating the recruiting process for preselected or agency conversion candidates. Like interns, preselected candidates do not attend an employer-hosted event for further evaluation. A hiring manager submits an agency conversion requisition with a candidate name to human resources as described in block 607. Next, human resources contacts the candidate and asks him or her to access the candidate web site and take the on-line skills questionnaire as described in block 609. Based on the candidate's assessment, the hiring manager decides whether to recommend the candidate for hire as described in block 611. If the candidate is recommended for hire, an offer is extended to the candidate as described in block 613. If the hiring manager does not recommend the candidate for hire, a new hiring manager conducts a structured interview with the candidate as described in block 615. Based on the interview, a second decision to hire is made as described in block 616.

### Employer-Hosted Recruiting Events

Generally, employer-hosted recruiting events comprise multi-day on-site activities during which event staff further evaluate invited candidates. Evaluation at each event comprises an interview of each invited candidate, an assessment of how each candidate interacts during one or more group activities and a job fit assessment from each candidate's pre-assigned mentor. Based on each candidate's evaluation, a hiring decision is made and communicated to each candidate prior to the conclusion of the event.

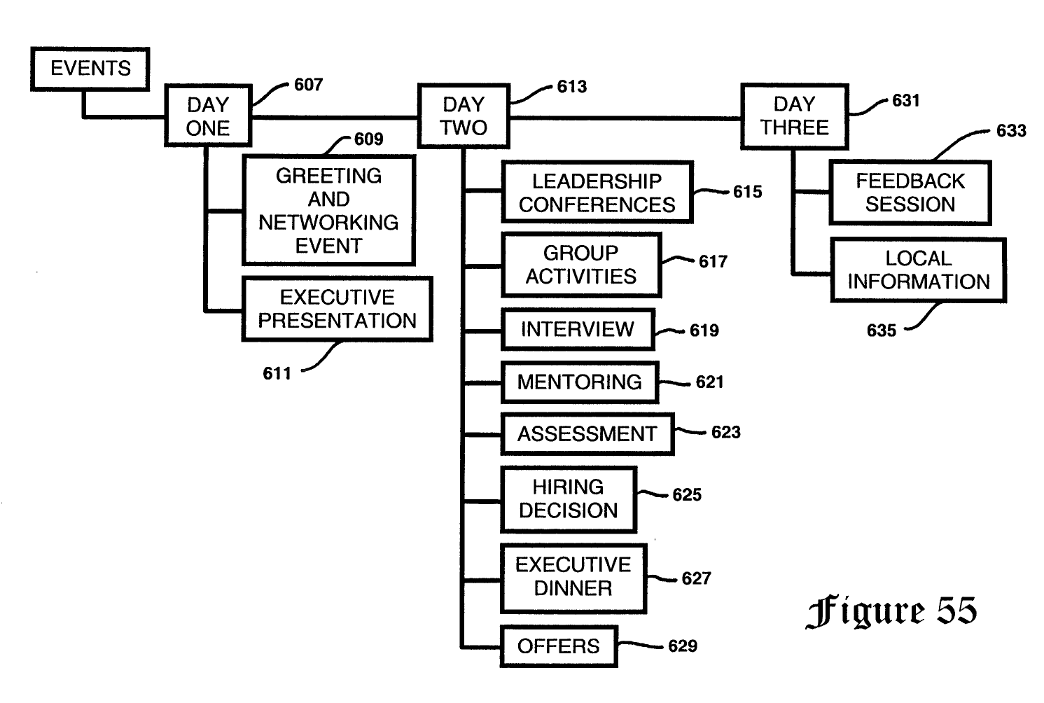

FIG. 55 is a block diagram illustrating an overview of an employer-hosted recruiting event in accord with a preferred embodiment of the present invention. The first day of each event 607 comprises a networking/greeting event 609 and an executive presentation 611. The second day 613 comprises business and technical leadership forums 615, group problem-solving activities 617, candidate interviews 619, discussions with mentors 621, candidate assessment 623, a hiring decision 625, dinner with executives 627, and distribution of offer/no offer letters to candidates 629. The third day 631 comprises a feedback session 633 for all candidates and a presentation 635 about relocation, benefits and geographic information for candidates who have received an offer letter.

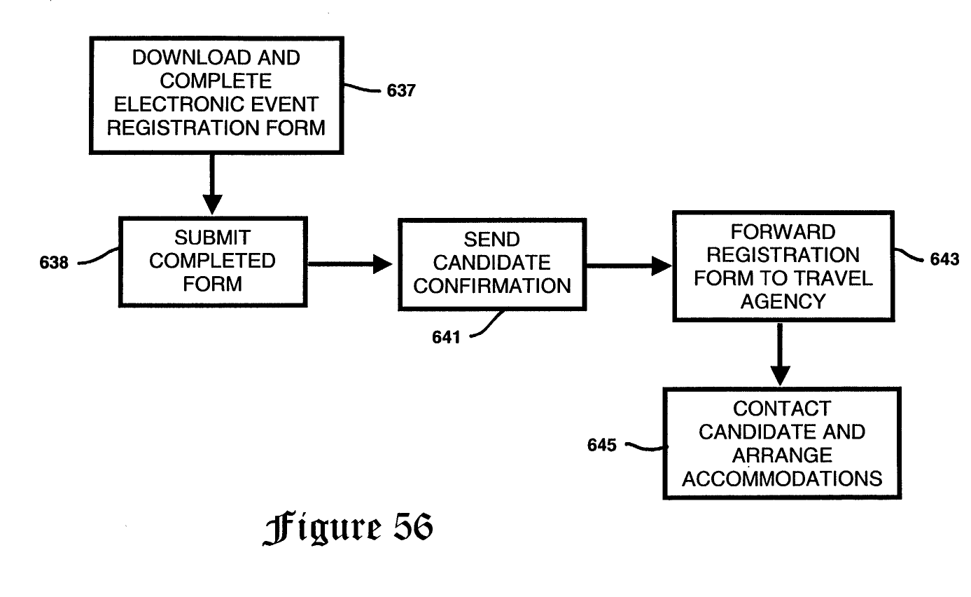

FIG. 56 is a block flow diagram illustrating the process by which invited candidates who accept an invitation to an employer-hosted recruiting event. First, the candidates visit their respective message centers at the candidate web site, download and complete an electronic event registration form as described in block 637. Preferably, the registration form allows candidates to specify any special air-fare preferences (e.g., window seat, handicap-equipped seating, etc.), lodging preferences (e.g., smoking/non-smoking etc.), dietary requirements and other special needs (e.g., wheel chair, etc.). After the candidate has submitted the electronic event registration form as described in block 638, the form is received by an event staff member. Upon receipt, the staff member sends a confirmation to the candidate as described in block 641 and forwards the registration form to a third party travel agency as described in block 643. Upon receipt, the travel agency contacts the candidate and arranges lodging, travel accommodations as described in block 645. Preferably, a new invitation for a later-scheduled event is sent to invited candidates who have not accepted a prior invitation. Additional invitations provide the candidate flexibility in scheduling around exams and other conflicts. After each candidate invited to an event completes the event registration, his or her name is added to a System database (i.e. candidate roster-not shown) of candidates confirmed to attend the event.

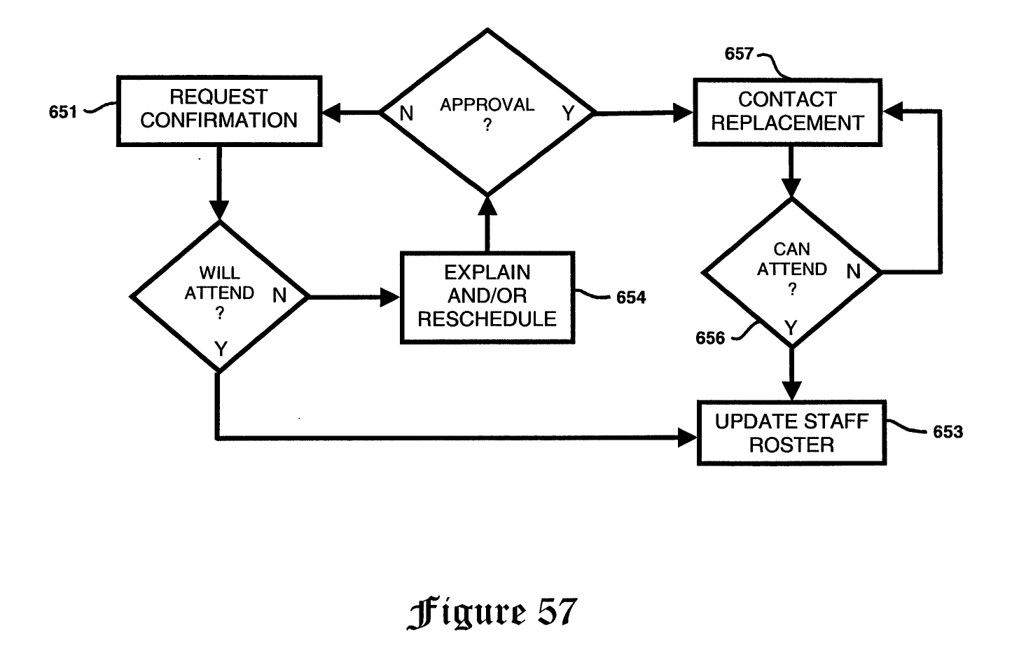

FIG. 57 is a block flow diagram illustrating the preliminary event staff registration process. Prior to a scheduled event, the System automatically sends an e-mail to each event staff member requesting them to confirm their attendance at the event as described in block 651. Event staff members who confirm their attendance are automatically added to a staff roster maintained within the System as described in block 653. Event staff members who cannot attend their event request approval for their absence or reschedule as described in block 654, and identify an alternate staff member (if possible) as described in block 657. Once a staff replacement is identified, contacted and confirmed as described in block 656, any necessary changes are made to the event schedule and corresponding staff roster as described in block 653.

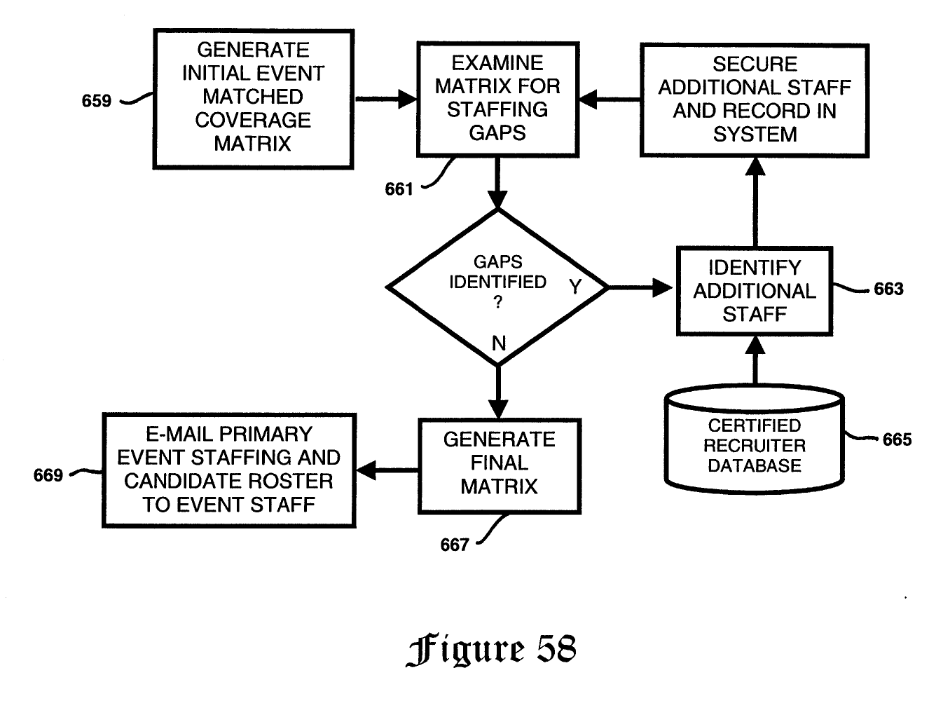

FIG. 58 is a block flow diagram illustrating the final event staffing process. Based on the candidate roster, the candidate registration data, the candidate schedules, the event staff roster and the finalized event profile, the System automatically generates an initial staff/candidate matching matrix as described in block 659 in which confirmed event staff members are assigned to confirmed candidates. For example, an interviewer, a mentor and a candidate buddy is assigned to each confirmed candidate.

Next, the staff/candidate matching matrix is examined for staffing gaps as described in block 661. If gaps exist, they are identified in terms of the event staff function (i.e., interviewer, mentor, buddy, etc.) and the time of the function is scheduled. Gaps are filled with certified staff members from the certified staff member database 665. After all identified gaps have been filled, the System generates a final staff/candidate matching matrix as described in block 667. Preferably, the System automatically e-mails the candidate roster, candidate schedules, the event staff roster and the final staff/candidate matching matrix to each event staff member prior to the event as described in block 669.

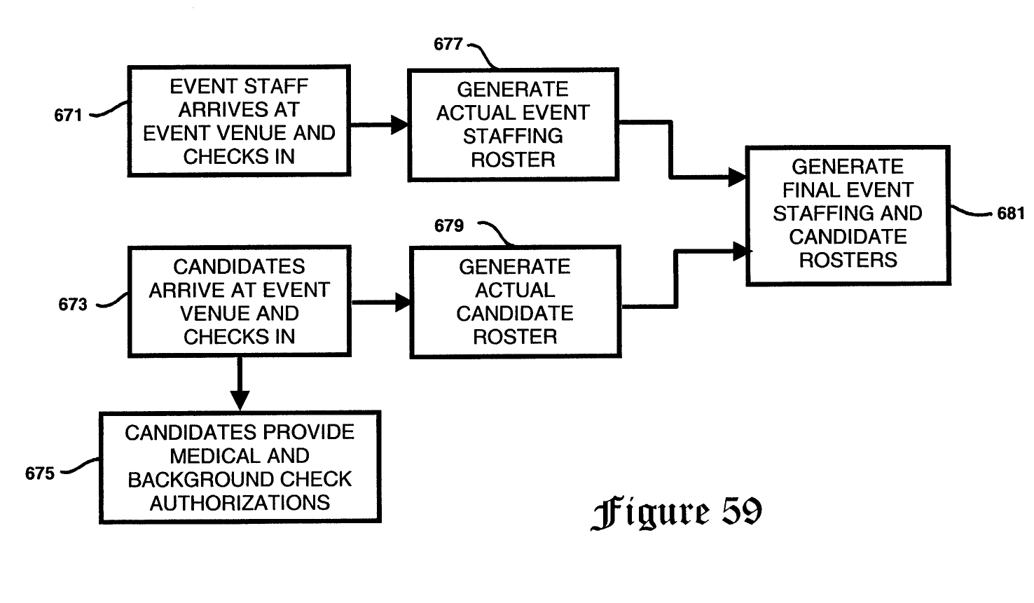

FIG. 59 is a block flow diagram illustrating the check-in process that takes place as recruiting event staff and candidates arrive at the on-site event. Upon arrival, each event staff member accesses the System and “checks-in” to the on-site event as described in block 671. Preferably, event staff members arrive one half hour prior to the event and check-in by swiping their bar-coded employee badge through a bar code scanner.

Like the event staff, each candidate accesses the System and checks-in upon arrival as described in block 673. In addition, each candidate provides an event staff member with a completed and signed authorization of medical and background checks as described in block 675.

Following check-in, the System generates an actual event staff roster distinguishing the event staff that have actually checked in to the event from the event staff that was scheduled to attend the event as described in block 677. Similarly, an actual candidate roster is generated distinguishing the candidates that have checked in the day of the event from the candidates who were scheduled to attend the event as described in block 679. After the actual event staff roster and actual candidate roster are generated, the System generates final event staffing and candidate schedules as described in block 681.

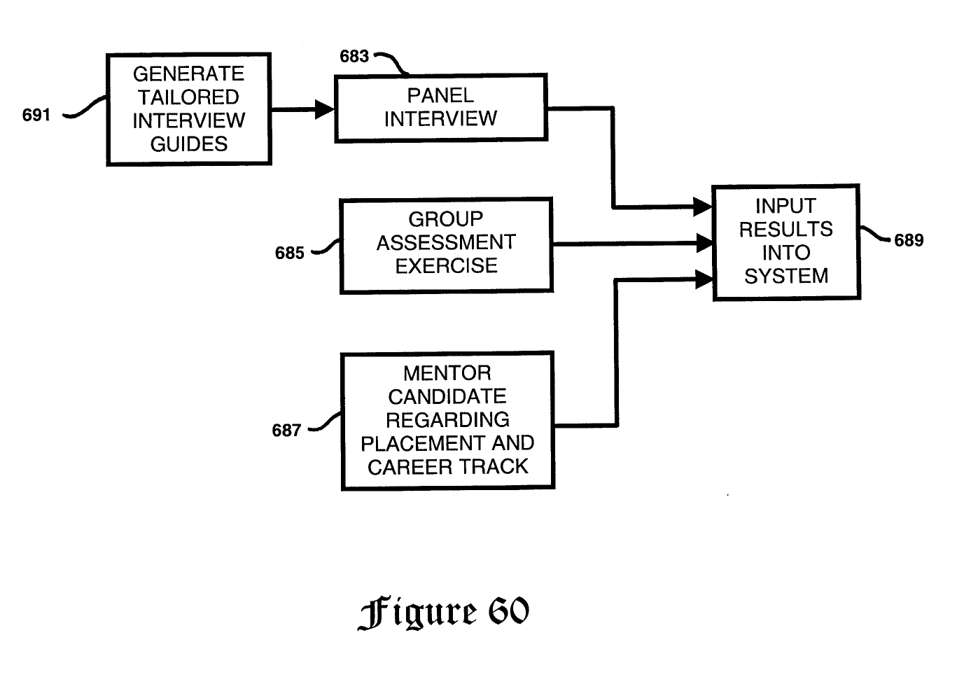

FIG. 60 is a block flow diagram illustrating the candidate evaluation process that takes place during the employer-hosted recruiting event. Candidate evaluation at the event is comprised of a structured panel interview 683 and group assessment exercise 685. Both tools are used to evaluate the candidate's leadership behaviors. The candidate also participates in a discussion with a mentor 687 to determine the candidate's job interests. As discussed in more detail infra, the results of each candidate's evaluation are input into the System during the second day of the event as described in block 689 and are evaluated during real time by the employer's human resources department.

Prior to each panel interview, the System generates an interview guide 691 for each candidate's interviewer. The interview guide comprises an interview template based on the candidate's on-line profile and requisition information for the employment opportunity to be filled. Shortly before interviewing the candidate, the interviewer accesses the System and downloads the appropriate interview guide.

Following the interview, the interviewers discuss the results of the interview, reach consensus on their ratings and offer decision, and input the interview results into the System. As previously described, FIG. 45 illustrates a System interface through which interviewers input the results of the candidate's interview. As discussed supra, candidates receive ratings on the following leadership behaviors: business acumen, innovation and technical excellence, drives diversity, courage, commitment to quality, does the right thing, and customer satisfaction. Ratings are made on a 9-point scale ranging from (1) “Ineffective” to (9) “Highly Effective” and include a “Not Applicable” option if the interviewers are unable to rate the leadership behavior. In addition to providing leadership behavior ratings, interviewers make an offer/no offer recommendation. They also provide a placement recommendation and behavioral comments listing specific reasons why they would/would not recommend the candidate to receive an offer.

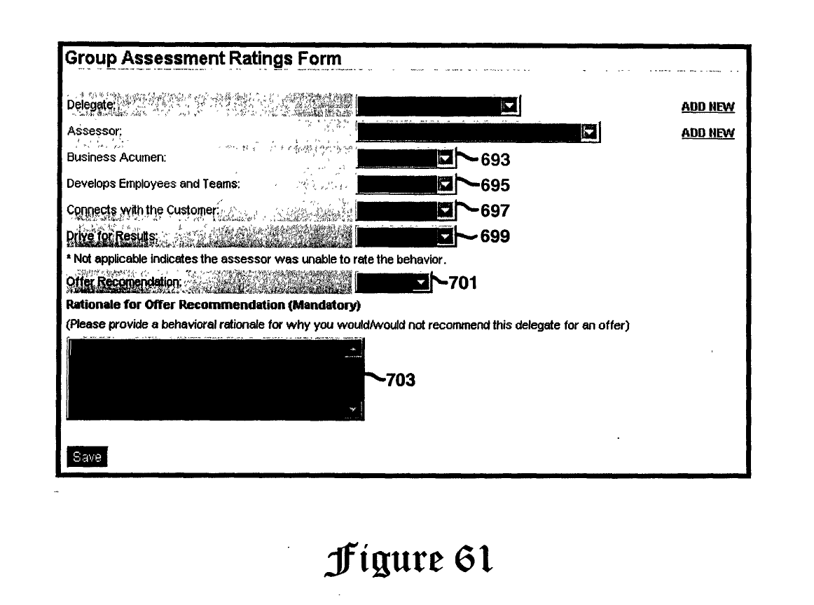

At the end of the group assessment exercise, the assessor accesses the System and inputs the assessment results. FIG. 61 illustrates a System interface through which a group assessor inputs the results of the candidate's group assessment. Candidates receive ratings on the following leadership behaviors: business acumen 693, drive for results 695, develops employees and teams 697, connects with customers 699. Ratings are made on a 9-point scale ranging from (1) “Ineffective” to (9) “Highly Effective” and include a “Not Applicable” option if the assessor is unable to rate the leadership behavior. In addition to providing leadership behavior ratings, the assessor makes an offer/no offer recommendation 701 and provides behavioral comments 703 listing specific reasons why the assessor would/would not recommend the candidate to receive an offer.

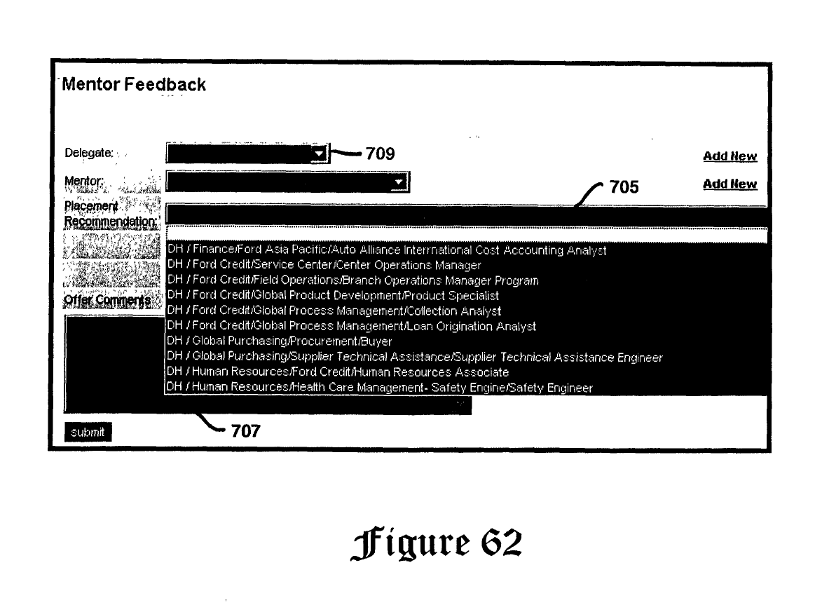

Mentors meet with candidates to discuss the candidates' placement and career track ambitions. After mentoring each candidate, the candidates' respective mentors access the System an input the mentoring results. FIG. 62 illustrates a System interface through which a mentor inputs an assessment of each candidate he or she has mentored. Mentor assessment includes but is not limited to a placement recommendation 705 and associated comments 707 for a given candidate/delegate 709.

Although they do not participate in the hiring decision, a candidate buddy is assigned to each candidate attending an event. Candidate buddies are current employees who provide each candidate with a peer contact for ongoing dialog throughout the event.

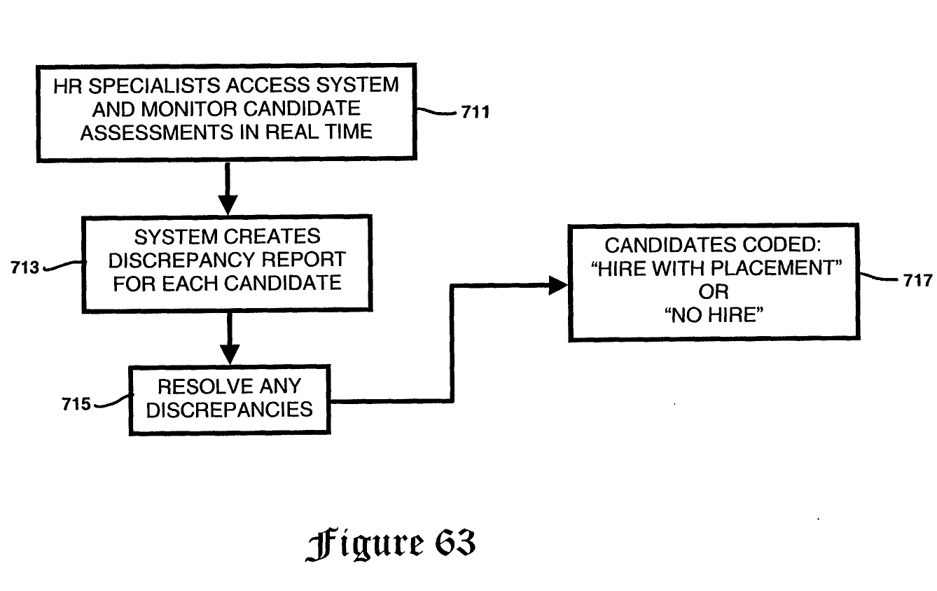

FIG. 63 is a block flow diagram illustrating the process for making a hiring decision during the employer-hosted recruiting event. In accord with a preferred embodiment of the present invention, human resources specialists access the System during the event and monitor the results of each candidate's assessment real-time as described in block 711. As the interviewers, group assessors and mentors input their respective candidates assessment into the System, the System creates a “discrepancy report” for each candidate as described in block 713. The discrepancy report highlights cases where the offer recommendation from the interview and the group assessment do not match. The human resources specialist reviews the ratings, determines the nature of the discrepancy, and either resolves the discrepancy or consults with the interviewer, group assessor, or other functional representative to resolve the discrepancy as described in block 715. Once resolved, the human resource specialist enters the final offer/no offer decision into the System as described in block 717. Preferably, the System assigns each candidate a code indicating whether the candidate is to receive an employment offer or rejection.

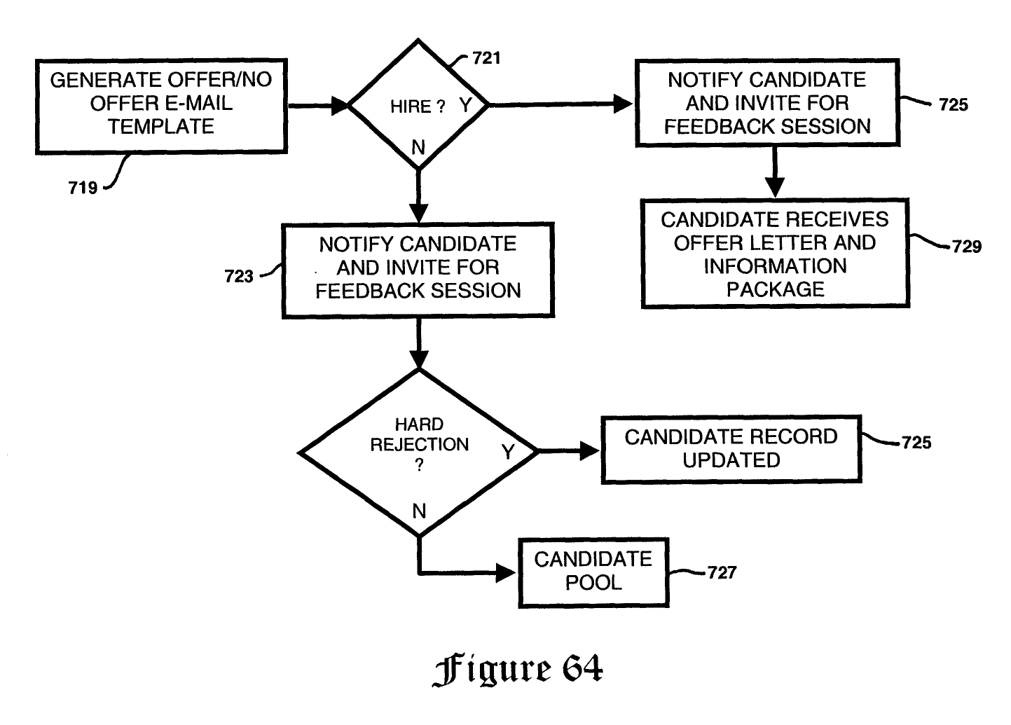

FIG. 64 illustrates the process for extending offer/no offer letters to candidates attending the employer-hosted recruiting events. Preferably, the System generates an offer and a no-offer e-mail template as described in block 719 for each candidate prior to the event based on the candidate's profile information (i.e., name, degree, school, etc.). After a decision is made to hire a particular candidate as described in block 721, the candidate's offer letter is reviewed to verify salary and placement. Any changes to the offer are made via the System.

In accord with a preferred embodiment of the present invention, all candidates attending an event are invited to participate in a feedback session after receiving their respective offer/no offer e-mails as described in blocks 723 and 725. Candidates who receive offers evaluate the hiring process and are provided with a hard copy of the offer letter and an information package 729 containing employee benefit, area housing and recreational information as described in block 729. Candidates receiving a no-offer letter evaluate the hiring process and are given suggestions by their respective event staff members regarding future interview performance.

If a candidate receives a hard rejection, the System is automatically updated to prevent that candidate from interviewing with the employer for a predefined period of time (e.g., one year) as described in block 725. If a candidate receives a soft rejection, that candidate's profile is added to a candidate pool and considered for future employment opportunities as described in block 727.

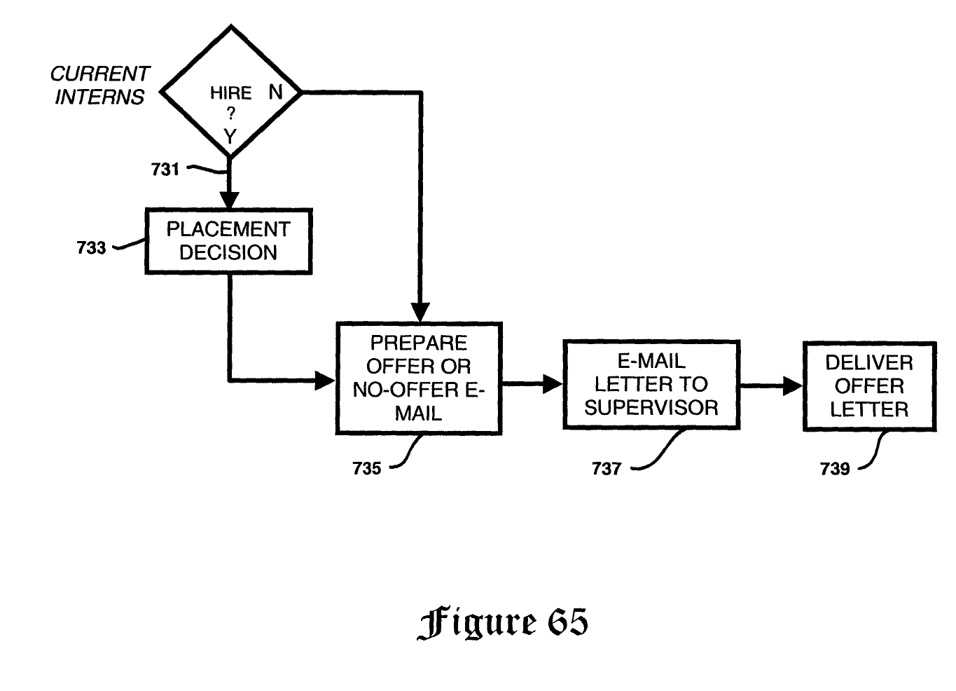

FIG. 65 illustrates the process for extending offer/no offer letters to current interns. If a decision is made to hire an intern as illustrated by arrow 731, a placement decision is made as described in block 733. Next, an offer/no offer e-mail is generated as described in block 735, reviewed to verify salary and placement and e-mailed to the intern's current supervisor as described in block 737. Upon receipt, the supervisor prints the offer/no offer letter and delivers it to the intern as described in block 739.

### Follow-Up

The follow-up step of the hiring process comprises the remaining activities necessary to bring candidates who have received an offer letter “on-board” with the employer. Follow-up activities include but are not limited to persuading the candidates to accept the employment offers, negotiating the terms of the offers with the candidates, accepting the offers, validating the candidates' credentials, drug-and medical screening and being generally available to the candidates for support.

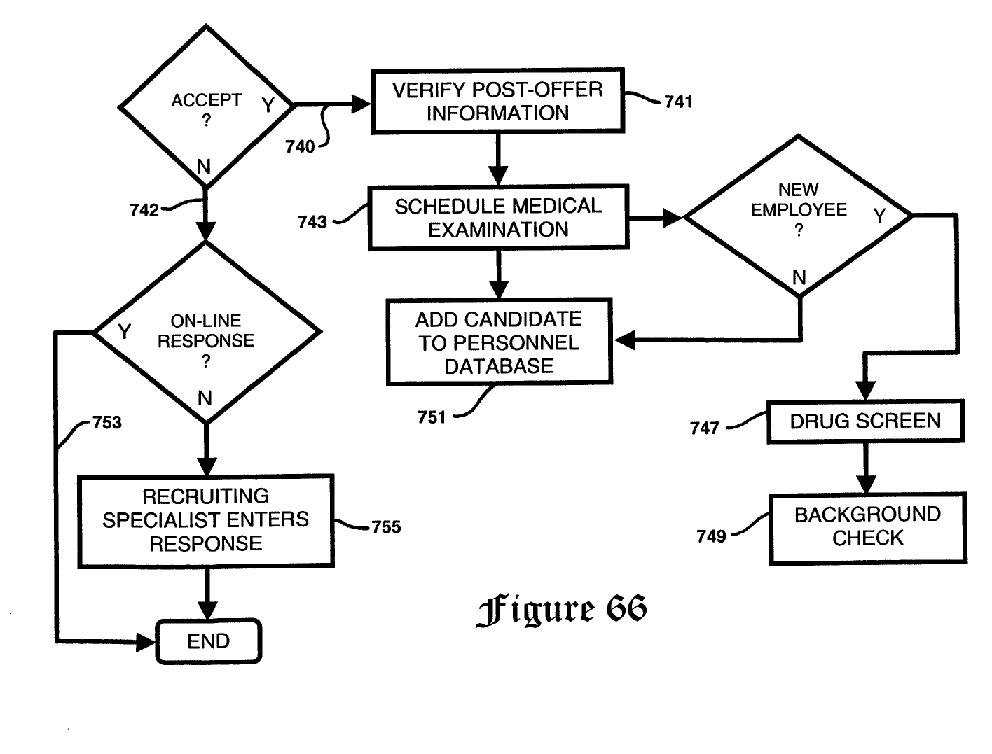

FIG. 66 illustrates the follow-up process for candidates who receive an offer letter. If the candidate accepts the offer as indicated by arrow 740, the new hire accesses the System and verifies post-offer information 741 including but not limited to the employment start date and location as described in block 741. If the new hire has not had a medical examination within a pre-defined time period (i.e., one year), the candidate schedules a medical examination as described in block 743. Preferably, the System provides the new hire with information regarding local facilities at which the new hire can schedule and receive a medical examination. If the new hire is a new employee (i.e., not a current intern or co-op), the new hire is required to additionally complete a drug screen as described in block 747 and background check as described in block 749. After the new hire has successfully completed any necessary medical, drug or background check, the new hire is added to the personnel database of “On-Board” employees as described in block 751.

Candidates who do not accept an employment offer as indicated by arrow 742 either respond on-line via their message center as indicated by arrow 753 or are contacted by a human resources specialist who accesses the System and enters the candidate's response as described in block 755.

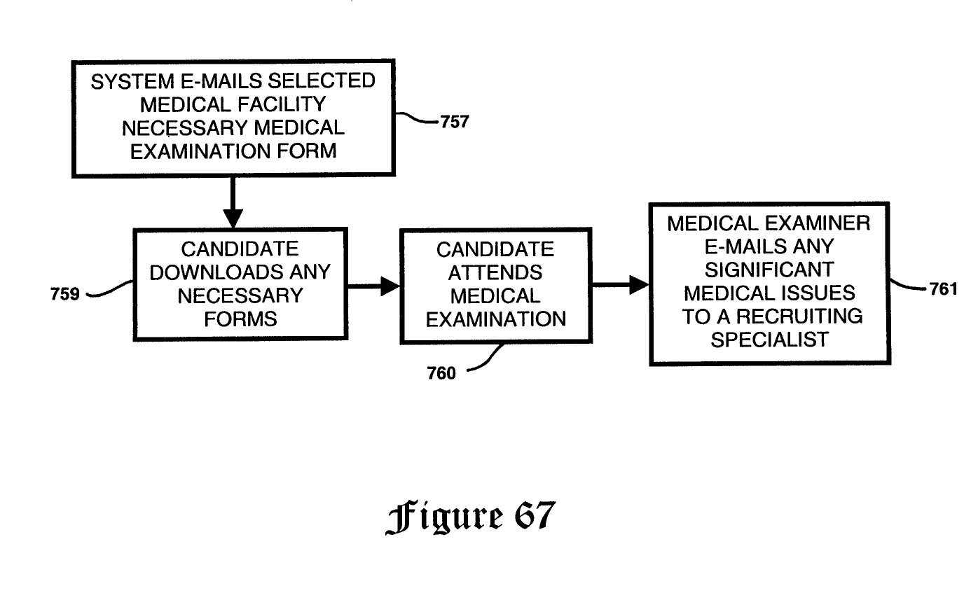

FIG. 67 is a block flow diagram illustrating the medical examination process in more detail. Preferably, the System automatically sends the selected medical facility a medical evaluation form for the candidate 757. If necessary, the System presents the candidate with any forms that may be necessary to take to the medical examination. The candidate downloads and prints any necessary forms 759 from his or her message center prior to attending the examination 760. In the event the candidate has a medical issue relevant to his employment, the examining office e-mails a recruiting specialist regarding the candidate's condition 761.

New hires authorized to receive an employer-paid relocation additionally receive relocation service information at their message center. Preferably, new employees access the System and provide their marital status and number of dependents to arrange for the payment of relocation expenses. Based on this information, the System authorizes the employer's accounting department to pay the moving agency responsible for relocating the new employee.

New hires authorized for an employer-paid automobile purchase receive automobile purchase registration information (e.g., application, new car options, dealer locations, payment information, etc.) at their message center. Preferably, the System presents each authorized new employee with a new car purchase voucher having a unique accounting number.

New hires authorized to receive a signing bonus access the System to verify the address to which the bonus check will be sent and agree to any terms and conditions associated with the bonus check. Automatically, the System sends an e-mail to a recruiting specialist requesting the signing bonus. In response, the recruiting specialist submits a check request to the accounting department who, in turn, disburses the signing bonus to the new employee at the specified address.

In accord with a preferred embodiment of the present invention, new hires receive information concerning a plurality of additional relocation services at their respective message centers. Relocation information includes but is not limited to house hunting services, rental assistance, home purchase assistance, pre-hire assistance and espousal assistance.

While the best mode for carrying out the invention has been described in detail, those familiar with the art to which this invention relates will recognize various alternative designs and embodiments for practicing the invention as defined by the following claims.

What is claimed:

1. An internet-based system for recruiting candidates for employment having at least one server computer operably connected to at least one database and serving a plurality of client computers, the at least one server computer being configured to:
receive input defining a plurality of employment requisitions wherein each employment requisition has associated candidate matching criteria;
host an interactive interface for presenting a plurality of candidates with an employment skills questionnaire;
assess each candidate based on a comparison between each candidate's employment skills and the candidate matching criteria; and
host an interactive interface for allocating the employer-hosted recruiting event invitations to candidates wherein the invitations are allocated based on the assessment.

2. The system of claim 1 additionally configured to host an interface for presenting a profile of each candidate wherein each profile comprises an assessment of how well a candidate's employment skills match the candidate matching criteria.

3. The system of claim 2 wherein each candidate profile additionally comprises an assessment of the candidate's leadership behaviors based on the skills questionnaire.

4. The system of claim 1 additionally configured to host an interface for defining and scheduling the employer-hosted recruiting events.

5. The system of claim 1 additionally configured to host an interface for receiving an assessment of each candidate attending an employer-hosted recruiting event.

6. The system of claim 5 wherein the assessment comprises an assessment of a candidate's interview performance.

7. The system of claim 5 wherein the assessment comprises an assessment of a candidate's performance during a group observation exercise.

8. The system of claim 5 wherein the assessment comprises a placement recommendation for the candidate wherein the recommendation is based on the candidate's discussions with a mentor.

9. The system of claim 5 additionally configured to host an interface for presenting each candidate's assessment in real-time during the employer-hosted recruiting event.

10. The system of claim 9 additionally configured to host an interface for selecting candidates for hire based on the assessment wherein the system automatically sends selected candidates an offer letter in an electronic format prior to the conclusion of the employer-hosted recruiting event.

11. The system of claim 1 additionally configured to host an interface for defining a plurality of university-specific recruiting web pages wherein each page comprises information for candidates regarding recruiters and on-campus recruiting activities at their university.

12. The system of claim 1 additionally configured to host an interface for defining hiring objectives wherein the hiring objectives comprise a target number of hires and diversity initiatives.

13. The system of claim 12 wherein the interface for defining hiring objectives presents a recruiting status report indicating the degree to which the hiring objectives have been met.
